(19) United States
(12) Patent Application Publication
(10) Pub. No.: US 2018/0031746 A1
(43) Pub. Date: Feb. 1, 2018

(54) PRESSURE-SENSITIVE-ADHESIVE-LAYER-ATTACHED POLARIZING FILM, METHOD FOR PRODUCING SAME, AND IMAGE DISPLAY DEVICE AND METHOD FOR CONTINUOUSLY PRODUCING SAME

(71) Applicant: NITTO DENKO CORPORATION, Ibaraki-shi, Osaka (JP)

(72) Inventors: Tomonori Ueno, Ibaraki-shi (JP); Satoshi Mita, Ibaraki-shi (JP); Yusuke Motegi, Ibaraki-shi (JP); Jingfan Xu, Ibaraki-shi (JP); Atsushi Kishi, Ibaraki-shi (JP)

(73) Assignee: NITTO DENKO CORPORATION, Ibaraki-shi, Osaka (JP)

(21) Appl. No.: 15/550,202

(22) PCT Filed: Feb. 10, 2016
(86) PCT No.: PCT/JP2016/053956

§ 371 Date: Aug. 10, 2017

(30) Foreign Application Priority Data
Feb. 13, 2015 (JP) 2015-026591
Feb. 8, 2016 (JP) 2016-021750

(51) Int. Cl. G02B 5/30; B32B 37/12; B32B 27/30; B32B 27/08; G02F 1/1335; C09J 7/02

(52) U.S. Cl. CPC G02B 5/305; G02F 1/1335; C09J 7/0217; B32B 27/306; C09J 7/0207; C09J 7/0278; B32B 27/08; B32B 37/1284

(57) ABSTRACT

The pressure-sensitive-adhesive-layer-attached polarizing film of the present invention has, in this order, a polarizer containing a polyvinyl alcohol-based resin, a transparent resin layer containing a polyvinyl alcohol-based resin, and a pressure-sensitive adhesive layer, wherein the pressure-sensitive adhesive layer is formed from a pressure-sensitive adhesive composition containing at least 0.1 parts by weight of an alkali metal salt with respect to 100 parts by weight of a base polymer, and satisfying the general expression (Y/X)≦3, where X is the abundance ratio of the alkali metal salt in a center part in the thickness direction of the pressure-sensitive adhesive layer, and Y is the abundance ratio of the alkali metal salt in the interface between the pressure-sensitive adhesive layer and the transparent resin layer. In the pressure-sensitive-adhesive-layer-attached polarizing film, the anchoring power of the transparent resin layer and the pressure-sensitive adhesive layer is good, and the antistatic function of the pressure-sensitive adhesive layer is also good.

### TECHNICAL FIELD

The invention relates to a pressure-sensitive-adhesive-layer-attached polarizing film and method for producing same. The pressure-sensitive-adhesive-layer-attached polarizing film may be used alone or as a component of a multilayer optical film to form an image display device such as a liquid crystal display (LCD) or an organic electroluminescent (EL) display.

### BACKGROUND ART

The image-forming system of liquid crystal displays or the like requires polarizing elements to be placed on both sides of a liquid crystal cell, and generally polarizing films are bonded thereto. A pressure-sensitive adhesive is commonly used to bond such polarizing films to a liquid crystal cell. When such polarizing films are bonded to a liquid crystal cell, a pressure-sensitive adhesive is generally used to bond the materials together so that optical loss can be reduced. In such a case, the pressure-sensitive adhesive is provided in advance as a pressure-sensitive adhesive layer on one side of a polarizing film, and the resulting pressure-sensitive-adhesive-layer-attached polarizing film is generally used because it has some advantages such as no need for a drying process to fix the polarizing film. A release film is generally provided to the pressure-sensitive adhesive layer of the pressure-sensitive-adhesive-layer-attached polarizing film.

During the manufacture of a liquid crystal display, the pressure-sensitive-adhesive-layer-attached polarizing film is bonded to a liquid crystal cell. In this process, static electricity is generated when the release film is peeled off from the pressure-sensitive adhesive layer of the pressure-sensitive-adhesive-layer-attached polarizing film. The static electricity generated in this manner may affect the orientation of the liquid crystal in the liquid crystal display to cause a failure. Therefore, in order to suppress generation of static electricity, it is required to impart an antistatic function to the pressure-sensitive adhesive layer. As a means for imparting an antistatic function to the pressure-sensitive adhesive layer, for example, it has been proposed to blend an ionic compound such as an alkali metal salt into a pressure-sensitive adhesive that forms the pressure-sensitive adhesive layer (Patent Documents 1 to 6).

Further, from the viewpoint of thinning, in the pressure-sensitive-adhesive-layer-attached polarizing film using a one-side-protected polarizing film provided a protective film only on one side of a polarizer, under a severe environment such as a thermal shock (for example, a 250 hour test at 95° C.), the difference between the shrinkage stress of the polarizer on the side to which the protective film was attached and the shrinkage stress of the polarizer on the opposite side to the protective film causes an excessive stress generated in the polarizer, resulting in various cracks tending to occur easily from micro cracks of several hundred μm in the absorption axis direction of the polarizer to through cracks penetrating the entire surface. That is, the pressure-sensitive-adhesive-layer-attached one-side-protected polarizing film had insufficient durability under such harsh environment.

In order to suppress the occurrence of the through cracks, for example, it is proposed to provide a pressure-sensitive-adhesive-layer-attached polarizing film including a one-side-protected polarizing film, a protective layer provided on the polarizing film and having a tensile elastic modulus of 100 MPa or more, and a pressure-sensitive adhesive layer provided on the protective layer (Patent Document 7). It is also proposed to provide a pressure-sensitive-adhesive-layer-attached polarizing film including a polarizer with a thickness of 25 μm or less, a protective layer provided on one surface of the polarizer and including a product obtained by curing a curable resin composition, a protective film provided on the other surface of the polarizer, and a pressure-sensitive adhesive layer provided on the outer side of the protective layer (Patent Document 8). The pressure-sensitive-adhesive-layer-attached polarizing films described in Patent Documents 7 and 8 are effective in terms of suppressing the occurrence of through cracks. In view of suppression of the occurrence of through cracks, thickness reduction, and weight reduction, it is proposed to form a protective layer on at least one surface of a polarizer from a water-soluble, film-forming composition (polyvinyl alcohol-based resin composition) (Patent Document 9).

### PRIOR ART DOCUMENTS

### Patent Documents

Patent Document 1: JP-B1-4746041

Patent Document 2: JP-B1-4549389

Patent Document 3: JP-B1-4856083

Patent Document 4: JP-A-2010-525098

Patent Document 5: JP-A-2008-031293

Patent Document 6: JP-A-2003-058859

Patent Document 7: JP-A-2010-009027

Patent Document 8: JP-A-2013-160775

Patent Document 9: JP-A-2005-043858

### SUMMARY OF THE INVENTION

### Problems to be Solved by the Invention

In Patent Documents 1 to 6, an antistatic function is imparted by applying a pressure-sensitive adhesive layer formed from a pressure-sensitive adhesive composition containing an ionic compound such as an alkali metal salt to a polarizing film. On the other hand, as described in Patent Documents 7 to 9, by providing a protective layer on the polarizer, the occurrence of through cracks in the absorption axis direction of the polarizer can be suppressed.

However, when a polyvinyl alcohol-based resin layer is provided as a protective layer on a pressure-sensitive adhesive layer containing an alkali metal salt or the like, the alkali metal salt in the pressure-sensitive adhesive layer segregates in the vicinity of the surface of the polyvinyl alcohol-based resin layer, and it was found that the anchoring power between the pressure-sensitive adhesive layer and the protective layer is lowered. In addition, it was also found that segregation of the alkali metal salt cannot sufficiently secure the antistatic function of the pressure-sensitive adhesive layer.

The purpose of the present invention is to provide a pressure-sensitive-adhesive-layer-attached polarizing film having, in this order, a polarizer containing a polyvinyl alcohol-based resin, a transparent resin layer containing a polyvinyl alcohol-based resin, and a pressure-sensitive adhesive layer, wherein the anchoring power of the transparent resin layer and the pressure-sensitive adhesive layer is good, and the antistatic function of the pressure-sensitive adhesive layer is also good.

Another object of the present invention is to provide a method for producing the pressure-sensitive-adhesive-layer-attached polarizing film. A still further object of the present invention is to provide an image display device having the pressure-sensitive-adhesive-layer-attached polarizing film, and a continuous production method thereof.

### Means for Solving the Problems

As a result of intensive studies, the inventors have accomplished the invention based on findings that the problems can be solved by the pressure-sensitive-adhesive-layer-attached polarizing film, and other means described below.

That is, the present invention relates to a pressure-sensitive-adhesive-layer-attached polarizing film having, in this order, a polarizer containing a polyvinyl alcohol-based resin, a transparent resin layer containing a polyvinyl alcohol-based resin, and a pressure-sensitive adhesive layer, wherein the pressure-sensitive adhesive layer is formed from a pressure-sensitive adhesive composition containing at least 0.1 parts by weight of an alkali metal salt with respect to 100 parts by weight of a base polymer, and satisfying the general expression (Y/X)≦3, where X is the abundance ratio of the alkali metal salt in a center part in the thickness direction of the pressure-sensitive adhesive layer, and Y is the abundance ratio of the alkali metal salt in the interface between the pressure-sensitive adhesive layer and the transparent resin layer.

In the pressure-sensitive-adhesive-layer-attached polarizing film, the transparent resin layer preferably is formed from a polyvinyl alcohol-based resin composition containing 0.2 to 20 parts by weight of an additive having a functional group capable of reacting with the functional group of the pressure-sensitive adhesive composition with respect to 100 parts by weight of the polyvinyl alcohol-based resin.

In the pressure-sensitive-adhesive-layer-attached polarizing film, the additive preferably segregates on the surface of the pressure-sensitive adhesive layer side of the transparent resin layer.

In the pressure-sensitive-adhesive-layer-attached polarizing film, the additive preferably has at least one primary alcohol at the molecular terminal.

In the pressure-sensitive-adhesive-layer-attached polarizing film, the additive preferably has a primary or secondary amino group in the molecule.

In the pressure-sensitive-adhesive-layer-attached polarizing film, the polyvinyl alcohol-based resin preferably has a saponification degree of 96 mol % or more and an average polymerization degree of 2000 or more.

In the pressure-sensitive-adhesive-layer-attached polarizing film, the transparent resin layer preferably has a thickness of 0.2 μm or more and 6 μm or less.

In the pressure-sensitive-adhesive-layer-attached polarizing film, the pressure-sensitive adhesive composition can contain a (meth)acrylic-based polymer as the base polymer and further can contain a crosslinking agent.

In the pressure-sensitive-adhesive-layer-attached polarizing film, the (meth)acrylic-based polymer preferably includes a hydroxyl group-containing monomer as a monomer unit.

In the pressure-sensitive-adhesive-layer-attached polarizing film, the crosslinking agent preferably includes an isocyanate-based compound.

In the pressure-sensitive-adhesive-layer-attached polarizing film, the alkali metal salt preferably includes a lithium salt.

In the pressure-sensitive-adhesive-layer-attached polarizing film, the polarizer preferably has a thickness of 15 μm or less.

In the pressure-sensitive-adhesive-layer-attached polarizing film, the polarizer preferably contains boric acid in an amount of 20% by weight or less with respect to the total amount of the polarizer.

In the pressure-sensitive-adhesive-layer-attached polarizing film, the polarizer preferably is configured in such a manner that the optical characteristics represented by the single-body transmittance T and the polarization degree P satisfy the condition of the following expression: P>−(10^{0.929T-42.4}−1)×100 (where T<42.3) or P≧99.9 (where T≧42.3).

In the pressure-sensitive-adhesive-layer-attached polarizing film, a protective film can be provided on the side opposite to the side where the transparent resin layer of the polarizer is provided.

In the pressure-sensitive-adhesive-layer-attached polarizing film, a separator can be laminated on the pressure-sensitive adhesive layer. The pressure-sensitive-adhesive-layer-attached polarizing film provided with the separator can be used as the form of a roll.

Further, the present invention relates to a method for producing the pressure-sensitive-adhesive-layer-attached polarizing film, comprising:

a step of coating a polyvinyl alcohol-based resin-containing polyvinyl alcohol-based resin composition on a polarizer containing a polyvinyl alcohol-based resin and then drying to form a transparent resin layer, and

a step of forming a pressure-sensitive adhesive layer on the transparent resin layer from a pressure-sensitive adhesive composition containing at least 0.1 parts by weight of an alkali metal salt with respect to 100 parts by weight of a base polymer.

Further, the present invention relates to an image display device having the pressure-sensitive-adhesive-layer-attached polarizing film.

Further, the present invention relates to a method for continuously producing an image display device, the method comprising the steps of:

unwinding the pressure-sensitive-adhesive-layer-attached polarizing film from the roll of the pressure-sensitive-adhesive-layer-attached polarizing film;

feeding the pressure-sensitive-adhesive-layer-attached polarizing film with the separator; and

continuously bonding the pressure-sensitive-adhesive-layer-attached polarizing film to a surface of an image display panel with the pressure-sensitive adhesive layer interposed therebetween.

### Effect of the Invention

The pressure-sensitive-adhesive-layer-attached polarizing film of the present invention has, in this order, a polarizer containing a polyvinyl alcohol-based resin, a transparent resin layer containing a polyvinyl alcohol-based resin, and a pressure-sensitive adhesive layer, wherein the pressure-sensitive adhesive layer is formed from a pressure-sensitive adhesive composition containing an alkali metal salt and the segregation of the alkali metal salt in the vicinity of the interface with the transparent resin layer is suppressed. That is, in the pressure-sensitive-adhesive-layer-attached polarizing film of the present invention, the abundance ratio Y of the alkali metal salt existing at the interface between the pressure-sensitive adhesive layer and the transparent resin layer is controlled so as to be three times or less of the abundance ratio X of the alkali metal salt in the pressure-sensitive adhesive layer. By controlling the abundance ratios X and Y of the alkali metal salt, the anchoring power of the transparent resin layer and the pressure-sensitive adhesive layer can be favorably maintained, and the antistatic function of the pressure-sensitive adhesive layer is also favorably ensured.

Control of the abundance ratios X and Y can be carried out, for example, by blending an additive having a functional group capable of reacting with a functional group of the pressure-sensitive adhesive composition into the polyvinyl alcohol-based resin composition forming the transparent resin layer.

In the above embodiment, for example, when the pressure-sensitive adhesive composition uses a (meth)acrylic-based polymer as the base polymer and contains a crosslinking agent and/or a silane coupling agent, it is thought that the additive reacts with the functional group of the pressure-sensitive adhesive composition at the interface between the transparent resin layer and the pressure-sensitive adhesive layer, thereby to be able to improve the anchoring power of the transparent resin layer and the pressure-sensitive adhesive layer. As a result, the pressure-sensitive-adhesive-layer-attached polarizing film of the present invention can prevent adhesive residue at the time of reworking, peeling off due to durability, and adhesive deficiency during processing. In addition, by improving the anchoring power by the additive, it is possible to suppress migration of the alkali metal salt in the pressure-sensitive adhesive layer to the transparent resin layer. Thus, it is considered that the antistatic function of the pressure-sensitive adhesive layer could be ensured.

### BRIEF DESCRIPTION OF THE DRAWINGS

FIG. 1 is a schematic cross-sectional view of examples of the pressure-sensitive-adhesive-layer-attached polarizing film of the invention.

FIG. 2 is a schematic cross-sectional view of examples of the pressure-sensitive-adhesive-layer-attached polarizing film of the invention.

FIG. 3 is a graph relating to the measurement of the abundance ratios X and Y of the alkali metal salt.

### MODE FOR CARRYING OUT THE INVENTION

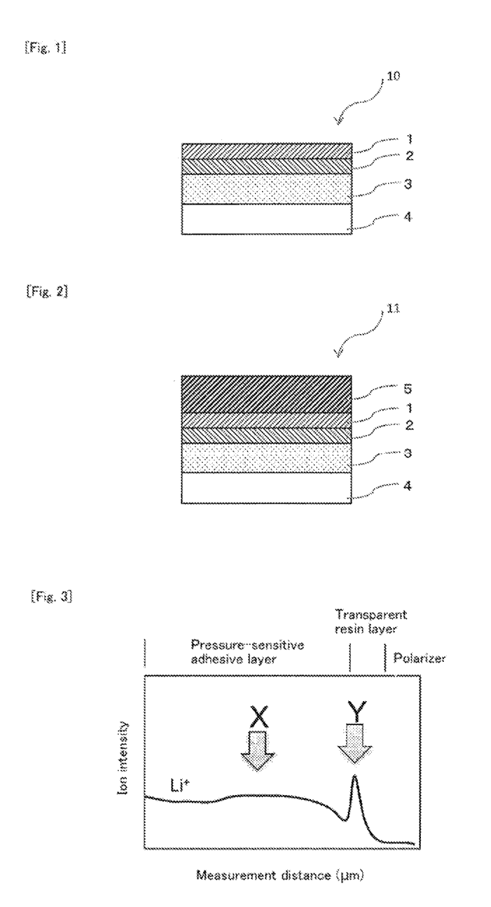

Hereinafter, the pressure-sensitive-adhesive-layer-attached polarizing films 10 and 11 of the present invention will be described with reference to FIGS. 1 and 2. The pressure-sensitive-adhesive-layer-attached polarizing films 10 and 11 have a polarizer 1, a transparent resin layer 2 containing a polyvinyl alcohol-based resin, and a pressure-sensitive adhesive layer 3 in this order. In the pressure-sensitive-adhesive-layer-attached polarizing films 10 and 11 of the present invention, as shown in FIG. 1, the transparent resin layer 2 formed of a forming material containing a polyvinyl alcohol-based resin is (directly) provided in the polarizer 1. FIG. 2 illustrates the case where the pressure-sensitive-adhesive-layer-attached polarizing film 10 has a protective film 5 on the side opposite to the side on which the transparent resin layer 2 of the polarizer 1 is provided. Although not shown in FIG. 2, the polarizer 1 and the protective film 5 are laminated via an intervening layer such as an adhesive layer, a pressure-sensitive adhesive layer, and an undercoat layer (a primer layer). Although not shown in the figure, the protective film 5 can be provided with an easy adhesive layer or subjected to activating treatment, so that the easy adhesive layer and the adhesive layer can be laminated. The protective film 5 can be laminated on one side of the polarizer 1.

As shown in FIGS. 1 and 2, the pressure-sensitive-adhesive-layer-attached polarizing films 10 and 11 of the present invention can be provided with a separator 4 on the pressure-sensitive adhesive layer 3. As shown in FIG. 2, when the pressure-sensitive-adhesive-layer-attached polarizing film 11 has the protective film 5, a surface protective film can be provided. The pressure-sensitive-adhesive-layer-attached polarizing film 11 having at least the separator 4 (furthermore, having a surface protective film 6) can be used as the form of a roll, and for example, it is possible to continuously produce the image display device by applying a pressure-sensitive-adhesive-attached polarizing film delivered from the form of a roll and conveyed by the separator to a method of bonding the polarizing film to the surface of an image display panel via a pressure-sensitive adhesive layer (also referred to as “roll-to-panel method, typically, see Japanese Patent No. 4406043 specification).

In the pressure-sensitive-adhesive-layer-attached polarizing films 10 and 11 of the present invention, the pressure-sensitive adhesive layer 3 is formed from a pressure-sensitive adhesive composition containing an alkali metal salt, and when the abundance ratio in the alkali metal salt at the pressure-sensitive adhesive layer 3 is X and the abundance ratio of the alkali metal salt at the interface between the pressure-sensitive adhesive layer 3 and the transparent resin layer 2 is Y, the abundance ratios X and Y are controlled to satisfy the general expression: (Y/X)≦3. By controlling the (Y/X) value as described above, the anchoring power of the transparent resin layer and the pressure-sensitive adhesive layer can be well maintained. From the viewpoint of the anchoring power, the (Y/X) value is preferably 2.5 or less, more preferably 2 or less. On the other hand, also from the viewpoint of antistatic property of the pressure-sensitive adhesive layer, the (Y/X) value is preferably 2.5 or less, more preferably 2 or less.

The abundance ratios X and Y can be measured by the method described in Examples.

The abundance ratios X and Y can be read by measuring the distribution of the alkali metal ion intensity (INTENSITY) in the cross section of the pressure-sensitive-adhesive-layer-attached polarizing film with use of a time-of-flight secondary ion mass spectrometer (TOF-SIMS) (trade name “TOF-SIMS 5”, manufactured by ION-TOF GmbH), as shown in the graph of FIG. 3.

The center part in the thickness direction of the pressure-sensitive adhesive layer related to the abundance ratio X is an intermediate point in the thickness direction (DISTANCE) of the pressure-sensitive adhesive layer in the graph. The interface between the pressure-sensitive adhesive layer and the transparent resin layer according to the abundance ratio Y is a critical point of the pressure-sensitive adhesive layer and the transparent resin layer in the thickness direction (DISTANCE) of the pressure-sensitive adhesive layer in the graph, and is shown as a peak top of the alkali metal ion intensity.

<Polarizer>

The polarizer used includes a polyvinyl alcohol-based resin. For example, the polarizer may be a product produced by a process including adsorbing a dichroic material such as iodine or a dichroic dye to a hydrophilic polymer film such as a polyvinyl alcohol-based film, a partially-formalized polyvinyl alcohol-based film, or a partially-saponified, ethylene-vinyl acetate copolymer-based film and uniaxially stretching the film, or may be a polyene-based oriented film such as a film of a dehydration product of polyvinyl alcohol or a dehydrochlorination product of polyvinyl chloride. Among these polarizers, a polarizer including a polyvinyl alcohol-based film and a dichroic material such as iodine is preferred. The thickness of these polarizers is not particularly limited, but is generally 2 to 25 μm.

For example, a polarizer including a uniaxially-stretched polyvinyl alcohol-based film dyed with iodine can be produced by a process including immersing a polyvinyl alcohol film in an aqueous iodine solution to dye the film and stretching the film to 3 to 7 times the original length. If necessary, the film may also be immersed in an aqueous solution of potassium iodide or the like optionally containing boric acid, zinc sulfate, zinc chloride, or other materials. If necessary, the polyvinyl alcohol-based film may be further immersed in water for washing before it is dyed. If the polyvinyl alcohol-based film is washed with water, dirt and any anti-blocking agent can be cleaned from the surface of the polyvinyl alcohol-based film, and the polyvinyl alcohol-based film can also be allowed to swell so that unevenness such as uneven dyeing can be effectively prevented. The film may be stretched before, while, or after it is dyed with iodine. The film may also be stretched in an aqueous solution of boric acid, potassium iodide, or the like or in a water bath.

The polarizer used can be a thin polarizer with a thickness of 15 μm or less. In view of thickness reduction and resistance to thermal shock-induced cracks, the polarizer preferably has a thickness of 12 μm or less, more preferably 10 μm or less, even more preferably 8 μm or less, further more preferably 7 μm or less, still more preferably 6 μm or less. On the other hand, the polarizer preferably has a thickness of 2 μm or more, more preferably 3 μm or more. The polarizer with such a small thickness is less uneven in thickness, has good visibility, and is less dimensionally-variable and thus has high durability to thermal shock.

In view of stretching stability and optical durability, the polarizer can contain boric acid. In order to suppress the occurrence of cracks such as through cracks and the like in the present invention, the content of boric acid in the polarizer is preferably 20% by weight or less, more preferably 18% by weight or less, even more preferably 16% by weight or less, based on the total weight of the polarizer. If the content of boric acid in the polarizer is more than 20% by weight, shrinkage stress in the polarizer can increase to make through cracks more likely to occur even when the thickness of the polarizer is controlled to 15 μm or less, which is not preferred. On the other hand, in view of the stretching stability and optical durability of the polarizer, the boron content is preferably 10% by weight or more, more preferably 12% by weight or more, based on the total weight of the polarizer.

Typical examples of the thin polarizer with a thickness of 15 μm or less include the thin polarizing films (polarizers) described in, for example, JP-B1-4751486, JP-B1-4751481, JP-B1-4815544, JP-B1-5048120, JP-B1-5587517, WO 2014/077599 A, and WO 2014/077636 A or thin polarizing films (polarizers) obtained by the production methods described in these publications.

The polarizer is preferably designed to have a single-body transmittance T and a polarization degree P that represent optical properties satisfying the condition of the following formula: P>−(10^{0.929T-42.4}−1)×100 (provided that T<42.3) or P≧99.9 (provided that T≧42.3). The polarizing film designed to satisfy the condition uniquely has the performance required for a liquid crystal television display having a large display element. Specifically, such a display is required to have a contrast ratio of 1,000:1 or more and a maximum brightness of 500 cd/m² or more. In other applications, for example, the polarizer is bonded to the viewer side of an organic EL display device.

The thin polarizing film described above should be produced by a process capable of achieving high-ratio stretching to improve polarizing performance, among processes including the steps of stretching and dyeing a laminate. From this point of view, the thin polarizing film is preferably obtained by a process including the step of stretching in an aqueous boric acid solution as described in JP-B1-4751486, JP-B1-4751481, or JP-B1-4815544, and more preferably obtained by a process including the step of performing auxiliary in-air stretching before stretching in an aqueous boric acid solution as described in JP-B1-4751481 or JP-B1-4815544. These thin polarizing films can be obtained by a process including the steps of stretching a laminate of a polyvinyl alcohol-based resin (hereinafter also referred to as PVA-based resin) layer and a stretchable resin substrate and dyeing the laminate. Using this process, the PVA-based resin layer, even when thin, can be stretched without problems such as breakage by stretching, because the layer is supported on the stretchable resin substrate.

<Protective Film>

The protective film is preferably made of a material having a high level of transparency, mechanical strength, thermal stability, water barrier properties, isotropy, and other properties. Examples of such a material include polyester-based polymers such as polyethylene terephthalate and polyethylene naphthalate, cellulose-based polymers such as diacetyl cellulose and triacetyl cellulose, acrylic-based polymers such as polymethyl methacrylate, styrene-based polymers such as polystyrene and acrylonitrile-styrene copolymers (AS resins), and polycarbonate-based polymers. Examples of polymers that may be used to form the transparent protective film also include polyolefin-based polymers such as polyethylene, polypropylene, cyclo-based or norbornene-structure-containing polyolefin, and ethylene-propylene copolymers, vinyl chloride-based polymers, amide-based polymers such as nylon and aromatic polyamide, imide-based polymers, sulfone-based polymers, polyether sulfone-based polymers, polyether ether ketone-based polymers, polyphenylene sulfide-based polymers, vinyl alcohol-based polymers, vinylidene chloride-based polymers, vinyl butyral-based polymers, arylate-based polymers, polyoxymethylene-based polymers, epoxy-based polymers, or any blends of the above polymers.

The protective film may also contain any type of one or more appropriate additives. Examples of such additives include ultraviolet absorbers, antioxidants, lubricants, plasticizers, release agents, discoloration preventing agents, flame retardants, nucleating agents, antistatic agents, pigments, and colorants. The content of the thermoplastic resin in the protective film is preferably from 50 to 100% by weight, more preferably from 50 to 99% by weight, even more preferably from 60 to 98% by weight, further more preferably from 70 to 97% by weight. If the content of the thermoplastic resin in the protective film is 50% by weight or less, high transparency and other properties inherent in the thermoplastic resin may fail to be sufficiently exhibited.

The protective film may also be, for example, a retardation film, a brightness enhancement film, or a diffusion film. The retardation film may have an in-plane retardation of 40 nm or more and/or a thickness direction retardation of 80 nm or more. The in-plane retardation is generally adjusted to fall within the range of 40 to 200 nm, and the thickness direction retardation is generally adjusted to fall within the range of 30 to 300 nm. When a retardation film is used as the protective film, the retardation film can also serve as a polarizer protecting film, which contributes to thickness reduction.

The retardation film may be a birefringent film formed by subjecting a thermoplastic resin film to uniaxial or biaxial stretching. The stretching temperature, the stretch ratio, and other conditions may be appropriately selected depending on the retardation value, the film material, and the thickness.

The thickness of the protective film may be selected as needed. In general, the thickness of the transparent protective film is from about 1 to about 500 μm in view of strength, workability such as handleability, and thin layer formability. In particular, the thickness of the transparent protective film is preferably from 1 to 300 μm, more preferably from 5 to 200 μm, even more preferably from 5 to 150 μm, further more preferably from 20 to 100 μm for thickness reduction.

The surface of the protective film, opposite to its surface where the polarizer is bonded (particularly in the mode shown in FIG. 1), may be provided with a functional layer such as a hard coat layer, an anti-reflection layer, an anti-sticking layer, a diffusion layer, or an antiglare layer. The functional layer such as a hard coat layer, an anti-reflection layer, an anti-sticking layer, a diffusion layer, or an antiglare layer may be provided as part of the protective film itself or as a layer independent of the protective film.

<Intervening Layer>

The protective film and the polarizer are laminated with an intervening layer, such as an adhesive layer, a pressure-sensitive adhesive layer, or an undercoat layer (primer layer), between them. In this case, the intervening layer should preferably be used to laminate them with no air gap between them.

The adhesive layer is made from an adhesive. Any of various types of adhesives maybe used. The adhesive layer may be of any optically-transparent type. The adhesive may be any of various types, such as a water-based adhesive, a solvent-based adhesive, a hot melt-based adhesive, and an active energy ray-curable adhesive. A water-based adhesive or an active energy ray-curable adhesive is preferred.

The water-based adhesive may be, for example, an isocyanate-based adhesive, a polyvinyl alcohol-based adhesive, a gelatin-based adhesive, a vinyl-based adhesive, a latex-based adhesive, or a water-based polyester adhesive. The water-based adhesive is generally used in the form of an aqueous solution, which generally has a solids content of 0.5 to 60% by weight.

The active energy ray-curable adhesive is an adhesive capable of being cured by exposure to active energy rays such as electron beams or ultraviolet rays (a radically or cationically curable adhesive). The active energy ray-curable adhesive to be used may be of, for example, an electron beam-curable type or an ultraviolet-curable type. The active energy ray-curable adhesive may be, for example, a photo-radically curable adhesive. The photo-radically curable type active energy ray-curable adhesive may be of an ultraviolet-curable type. In this case, the adhesive should contain a radically polymerizable compound and a photopolymerization initiator.

The method for applying the adhesive is appropriately selected depending on the viscosity of the adhesive and the desired thickness. Examples of application means include a reverse coater, a gravure coater (direct, reverse, or offset), a bar reverse coater, a roll coater, a die coater, a bar coater, and a rod coater. Any other suitable application method such as dipping may also be used.

For example, when the water-based adhesive is used, the adhesive is preferably applied in such a manner that the finally formed adhesive layer can have a thickness of 30 to 300 nm. The adhesive layer more preferably has a thickness of 60 to 250 nm. On the other hand, when the active energy ray-curable adhesive is used, the adhesive layer is preferably formed with a thickness of 0.1 to 200 μm. The thickness is more preferably from 0.5 to 50 μm, even more preferably from 0.5 to 10 μm.

In the process of laminating the polarizer and the protective film, an adhesion-facilitating layer may be placed between the protective film and the adhesive layer. The adhesion-facilitating layer may be made of, for example, any of various resins having a polyester skeleton, a polyether skeleton, a polycarbonate skeleton, a polyurethane skeleton, a silicone skeleton, a poly amide skeleton, a polyimide skeleton, a polyvinyl alcohol skeleton, or other polymer skeletons. These polymer resins may be used singly or in combination of two or more. Other additives may also be added to form the adhesion-facilitating layer. More specifically, a tackifier, an ultraviolet absorber, an antioxidant, or a stabilizer such as a heat-resistant stabilizer may also be used to form the adhesion-facilitating layer.

The adhesion-facilitating layer is usually provided in advance on the protective film, and then the adhesion-facilitating layer side of the protective film is bonded to the polarizer with the adhesive layer. The adhesion-facilitating layer can be formed using a known technique that includes applying an adhesion-facilitating-layer-forming material onto the protective film and drying the material. The adhesion-facilitating-layer-forming material is generally prepared in the form of a solution which is diluted to a suitable concentration taking into account the coating thickness after drying, the smoothness of the application, and other factors. After dried, the adhesion-facilitating layer preferably has a thickness of 0.01 to 5 μm, more preferably 0.02 to 2 μm, even more preferably 0.05 to 1 μm. Two or more adhesion-facilitating layers may be provided. Also in this case, the total thickness of the adhesion-facilitating layers preferably falls within these ranges.

The pressure-sensitive adhesive layer is made from a pressure-sensitive adhesive. Any of various pressure-sensitive adhesives may be used, examples of which include rubber-based pressure-sensitive adhesives, acryl-based pressure-sensitive adhesives, silicone-based pressure-sensitive adhesives, polyurethane-based pressure-sensitive adhesives, vinyl alkyl ether-based pressure-sensitive adhesives, polyvinylpyrrolidone-based pressure-sensitive adhesives, polyacrylamide-based pressure-sensitive adhesives, and cellulose-based pressure-sensitive adhesives. The base polymer with adhesive properties is selected depending on the type of the pressure-sensitive adhesive. Among these pressure-sensitive adhesive adhesives, acryl-based pressure-sensitive adhesives are preferably used because they have a high level of optical transparency, weather resistance, heat resistance, and other properties, and exhibit an appropriate level of wettability and adhesive properties including cohesiveness and adhesiveness.

The undercoat layer (primer layer) is formed to improve the adhesion between the polarizer and the protective film. The primer layer may be made of any material capable of providing somewhat strong adhesion to both the base film and a polyvinyl alcohol-based resin layer. For example, a thermoplastic resin having a high level of transparency, thermal stability, and stretchability may be used to form the primer layer. Such a thermoplastic resin may foe, for example, an acryl-based resin, a polyolefin-based resin, a polyester-based resin, a polyvinyl alcohol-based resin, or any mixture thereof.

<Transparent Resin Layer>

The transparent resin layer contains a polyvinyl alcohol-based resin. The polyvinyl alcohol-based resin used to form the transparent resin layer may foe the same as or different from the polyvinyl alcohol-based resin in the polarizer as long as it falls under the category of “polyvinyl alcohol-based resin.”

The transparent resin layer can be formed, for example, by applying a polyvinyl alcohol-based resin composition containing a polyvinyl alcohol-based resin to a polarizer. When a polyvinyl alcohol-based resin is used as the transparent-resin layer, the boric acid contained in the polarizer partly leaks into the transparent resin layer during the process of forming the transparent resin layer, so that the boric acid content in the polarizer is reduced. Thus, cracks and the like due to thermal shocks are less likely to occur in the polarizer itself. The thickness of the transparent resin layer is preferably 0.2 μm or more, and occurrence of cracks due to thermal shock can be suppressed by the transparent resin layer having such a thickness. The thickness of the transparent resin layer is preferably 0.5 μm or more, more preferably 0.7 μm or more. On the other hand, when the transparent resin layer becomes too thick, the optical reliability and water resistance are lowered, so the thickness of the transparent resin layer is preferably 6 μm or less, more preferably 5 μm or less, even more preferably 3 μm or less, yet even more preferably 2 μm or less.

The polyvinyl alcohol-based resin may be, for example, polyvinyl alcohol. Polyvinyl alcohol can be obtained by saponifying polyvinyl acetate. The polyvinyl alcohol-based resin may also be a product produced by saponifying a copolymer of vinyl acetate and any other monomer or monomers copolymerizable therewith. In this case, when the copolymerizable monomer is ethylene, an ethylene-vinyl alcohol copolymer can be obtained. Examples of the copolymerizable monomer include unsaturated carboxylic acids such as maleic acid (anhydride), fumaric acid, crotonic acid, itaconic acid, and (meth)acrylic acid, and esters thereof; α-olefins such as ethylene and propylene; (sodium) (meth)allylsulfonate, sodium sulfonate (monoalkyl maleate), sodium disulfonate alkyl maleate, N-methylolacrylamide, acrylamide alkyl sulfonate alkali salts, N-vinylpyrrolidone, and N-vinylpyrrolidone derivatives. These polyvinyl alcohol-based resins may be used alone or in combination of two or more. From the viewpoint of satisfying moist heat resistance and water resistance by controlling the heat of crystal fusion of the transparent resin layer to 30 mj/mg or more, a polyvinyl alcohol obtained by saponifying a polyvinyl acetate is preferred.

The polyvinyl alcohol-based resin to be used may have a saponification degree of, for example, 95% by mole or more. In view of the transparent resin layer can have a satisfactory level of moist beat resistance or water resistance, the polyvinyl alcohol-based resin preferably has a saponification degree of 96% by mole or more, more preferably 99% by mole or more, even more preferably 99.5% by mole or more. The saponification degree indicates the proportion of the units actually saponified to vinyl alcohol units in the units capable of being converted to vinyl alcohol units by saponification, after which vinyl ester units can remain as residues. The saponification degree can be determined according to JIS K 6726-1994.

The polyvinyl alcohol-based resin to be used may have an average degree of polymerization of, for example, 500 or more. In view of the transparent resin layer can have a satisfactory level of moist heat resistance or water resistance, the polyvinyl alcohol-based resin preferably has an average degree of polymerization of 1,000 or more, more preferably 1,500 or more, even more preferably 2,000 or more. The average degree of polymerization of the polyvinyl alcohol-based resin can be measured according to JIS K 6726.

The polyvinyl alcohol-based resin to be used may also be a modified polyvinyl alcohol-based resin having a hydrophilic functional group on the side chain of the polyvinyl alcohol or copolymerized polyvinyl alcohol. The hydrophilic functional group may be, for example, an acetoacetyl group or a carbonyl group. Other examples of the polyvinyl alcohol resin that may be used include modified polyvinyl alcohols obtained by, for example, acetalization, urethanation, etherification, or phosphorylation of polyvinyl alcohol resin or grafting on polyvinyl alcohol resin.

The transparent resin layer in the present invention is formed from a polyvinyl alcohol-based resin composition containing the polyvinyl alcohol-based resin as a main component, but the forming material may contain an additive. As the additive, it is possible to use an additive having a functional group capable of reacting with a functional group possessed by a pressure-sensitive adhesive composition described below (in particular, a base polymer ((meth)acrylic-based polymer) and/or a crosslinking agent in the pressure-sensitive adhesive composition). By introducing the additive into the transparent resin layer, the reaction with the base polymer ((meth)acrylic-based polymer) and/or the crosslinking agent in the pressure-sensitive adhesive composition forming the pressure-sensitive adhesive layer progresses to be able to improve the anchoring power between the transparent resin layer and the pressure-sensitive adhesive layer. For example, when a (meth)acrylic-based polymer is used as the base polymer of the pressure-sensitive adhesive composition described below, an additive having a functional group capable of reacting with the functional group of the (meth)acrylic-based polymer and/or the crosslinking agent is selected.

When the additive is blended into the polyvinyl alcohol-based resin composition, the polyvinyl alcohol-based resin is preferably one which does not have a functional group having reactivity with the functional group of the additive, and an unmodified polyvinyl alcohol-based resin is preferably used. Alternatively, in the case of using an unmodified polyvinyl alcohol-based resin, it is preferable that the hydrophilic functional group related to the modification may have less reactivity than the functional groups of the base polymer and/or the crosslinking agent in the pressure-sensitive adhesive composition in relation to the functional group of the additive.

The additive is blended in a ratio of, for example, 0.2 parts by weight or more and 20 parts by weight or less with respect to 100 parts by weight of the polyvinyl alcohol-based resin. In order to improve the anchoring power, it is preferable to set the proportion of the additive to 0.2 parts by weight or more. The proportion of the additive is preferably 1 part by weight or more, more preferably 3 parts by weight or more. On the other hand, as the proportion of the additive increases, the water resistance deteriorates. Therefore, the proportion of the additive is preferably 20 parts by weight or less, more preferably 10 parts by weight or less. The proportion of the additive is determined by the type of the base polymer ((meth)acrylic-based polymer) and the crosslinking agent used in the pressure-sensitive adhesive composition, the blending amount thereof, the kind of the alkali metal salt and the blending amount thereof.

The content of the polyvinyl alcohol-based resin in the transparent resin layer or the polyvinyl alcohol-based resin composition (solid basis) is preferably 80% by weight or more, more preferably 90% by weight or more, even more preferably 95% by weight or more.

The segregation of the additive on the surface of the pressure-sensitive adhesive layer side in the transparent resin layer can suppress the segregation of the alkali metal salt in the pressure-sensitive adhesive layer to the vicinity of the interface with the transparent resin layer, and this is preferable from the viewpoint of the anchoring power. The segregation of the additive can foe observed by TOF-SIMS with Ar clusters. The segregation can be judged from the ionic strength distribution derived from the additive.

As the additive, a compound having at least one primary alcohol at the molecular terminal can be suitably used. Examples of such a compound include amino-formaldehyde resins such as condensates of methylol urea, methylol melamine, or alkylated methylol urea with formaldehyde, ethylene glycol, glycerin, 1,6-hexanediol, 1,8-octanediol, aliphatic alcohol, and polyethylene glycol. Of these, amino-formaldehyde resins having a methylol group, especially methylol melamine is preferred. For example, a compound having a primary alcohol at the molecular terminal is suitable when the base polymer of the pressure-sensitive adhesive composition has a hydroxyl group (when the base polymer is a (meth)acrylic-based polymer, a hydroxyl group-containing monomer is contained as a monomer unit) or when an isocyanate-based compound is contained as a crosslinking agent.

As the additive, a compound having a primary or secondary amino group in the molecule can be suitably used. Examples of such compounds include alkylene diamines having an alkylene group and two amino groups, such as ethylenediamine, triethylenediamine, and hexamethylenediamine; hydrazine; dicarboxylic acid dihydrazides, such as adipic acid dihydrazide, oxalic acid dihydrazide, malonic acid dihydrazide, succinic acid dihydrazide, glutaric acid dihydrazide, isophthalic acid dihydrazide, sebacic acid dihydrazide, maleic acid dihydrazide, fumaric acid dihydrazide, and itaconic acid dihydrazide; water-soluble dihydrazines, such as ethylene-1,2-dihydrazine, propylene-1,3-dihydrazine, and butylene-1,4-dihydrazine; and the like. Of these, hydrazine is preferable. The compound having an amino group at the molecular terminal is suitable, for example, when the base polymer of the pressure-sensitive adhesive composition has a hydroxyl group (when the base polymer is a (meth)acrylic-based polymer, a hydroxyl group-containing monomer is contained as a monomer unit) or when an isocyanate-based compound is contained as a crosslinking agent.

The polyvinyl alcohol-based resin composition forming the transparent resin layer may contain, in addition to the additives, a curable component (crosslinking agent) and the like. As the crosslinking agent, a compound having at least two functional groups reactive with the polyvinyl alcohol-based resin can be used. Examples of the crosslinking agent include isocyanates (e.g. tolylene diisocyanate, hydrogenated tolylene diisocyanate, trimethylolpropane tolylene diisocyanate adduct, triphenylmethane triisocyanate, methylene bis(4-phenylmethane triisocyanate, isophorone diisocyanate, ketoxime block products or phenol block products thereof, etc.); epoxies (e.g. ethylene glycol diglycidyl ether, polyethylene glycol diglycidyl ether, glycerin di- or tri-glycidyl ether, 1,6-hexanediol diglycidyl ether, trimethylolpropane triglycidyl ether, diglycidyl aniline, diglycidyl amine, etc.); monoaldehydes (e.g. formaldehyde, acetaldehyde, propionaldehyde, butylaldehydes, etc.); dialdehydes (e.g. glyoxal, malondialdehyde, succindialdehyde, glutardialdehyde, maleic dialdehyde, phthaldialdehyde, etc.); amino-formaldehyde resins (e.g. condensates of formaldehyde with alkylated methylol melamine, acetoguanamine or benzoguanamine, etc.); and salts or oxides of divalent or trivalent metals (e.g. sodium, potassium, magnesium, calcium, aluminum, iron, nickel, etc.). Among these, amino-formaldehyde resins and water-soluble dihydrazines are preferable. As the amino-formaldehyde resin, a compound having a methylol group is preferable, and methylol melamine which is a compound having a methylol group is particularly preferable.

The curable component (cross-linking agent) can be used from the viewpoints of improvement in water resistance and control of elastic modulus, but the proportion to be used is preferably 20 parts by weight or less, more preferably 10 parts by weight or less, even more preferably 5 parts by weight or less, with respect to 100 parts by weight of the polyvinyl alcohol-based resin.

The polyvinyl alcohol-based resin composition may be prepared as a solution by dissolving the polyvinyl alcohol-based resin in a solvent. Examples of the solvent include water, dimethyl sulfoxide, dimethylformamide, dimethylacetamide and N-methylpyrrolidone. These solvents may be used alone or in combination of two or more. Among them, water is preferably used as the solvent to form the layer-forming material as an aqueous solution. The concentration of the polyvinyl alcohol-based resin in the layer-forming material (e.g., an aqueous solution) maybe, but not limited to, 0.1 to 15% by weight, preferably 0.5 to 10% by weight, in view of coatability, shelf stability, and other properties.

In addition, materials other than the above additives may be added to the layer-forming material (for example, aqueous solution). Examples of such other additives include surfactants and the like. The surfactant may be, for example, a nonionic surfactant. The layer-forming material may also contain a coupling agent such as a silane coupling agent or a titanium coupling agent, any of various tackifiers, an ultraviolet absorber, an antioxidant, and a stabilizer such as a heat-resistant stabilizer or a hydrolysis-resistant stabilizer.

The transparent resin layer may be formed by applying the layer-forming material to the other surface of the polarizer (the surface opposite to its surface on which the protective film is provided) and drying the material. The layer-forming material is preferably applied in such a manner that a 0.2 to 6 μm-thick coating can be formed after drying. The application process is not limited, and any appropriate method may be used in the application process. For example, roll coating, spin coating, wire bar coating, dip coating, die coating, curtain coating, spray coating, knife coating (such as comma coating), or various other methods may be used.

<Pressure-Sensitive Adhesive Layer>

The pressure-sensitive adhesive layer is formed from a pressure-sensitive adhesive composition containing a base polymer and an alkali metal salt. The pressure-sensitive adhesive layer may be formed using any appropriate type of pressure-sensitive adhesive. Examples of the pressure-sensitive adhesive include a rubber-based pressure-sensitive adhesive, an acryl-based pressure-sensitive adhesive, a silicone-based pressure-sensitive adhesive, a urethane-based pressure-sensitive adhesive, a vinyl alkyl ether-based pressure-sensitive adhesive, a polyvinyl alcohol-based pressure-sensitive adhesive, a polyvinylpyrrolidone-based pressure-sensitive adhesive, a polyacrylamide-based pressure-sensitive adhesive, and a cellulose-based pressure-sensitive adhesive. Various base polymers can be used depending on these pressure-sensitive adhesives.

Among these pressure-sensitive adhesives, those having a high level of optical transparency and weather resistance or heat resistance and exhibiting an appropriate level of wettability and adhesive properties such as cohesiveness and adhesiveness are preferably used. An acryl-based pressure-sensitive adhesive is preferably used because it has such properties. As the base polymer of the acrylic pressure-sensitive adhesive, a (meth)acrylic-based polymer is used. The (meth)acrylic-based polymer includes an alkyl (meth) acrylate monomer unit as a main component. The term “(meth)acrylate” refers to acrylate and/or methacrylate, and “(meth)” is used in the same meaning in the description.

The alkyl (meth)acrylate used to form the main skeleton of the (meth)acrylic-based polymer may have a straight- or branched-chain alkyl group of 1 to 18 carbon atoms. Examples of such an alkyl group include methyl, ethyl, propyl, isopropyl, butyl, isobutyl, amyl, hexyl, cyclohexyl, heptyl, 2-ethylhexyl, isooctyl, nonyl, decyl, isodecyl, dodecyl, isomyristyl, lauryl, tridecyl, pentadecyl, hexadecyl, heptadecyl, and octadecyl groups. These may be used singly or in any combination. The average number of carbon atoms in the alkyl group is preferably from 3 to 9.

In order to improve tackiness or heat resistance, one or more copolymerizable monomers having an unsaturated double bond-containing polymerizable functional group such as a (meth)acryloyl group or a vinyl group may be introduced into the (meth)acrylic-based polymer by copolymerization. Examples of such copolymerizable monomers include hydroxyl group-containing monomers such as 2-hydroxyethyl (meth)acrylate, 3-hydroxypropyl (meth)acrylate, 4-hydroxybutyl (meth)acrylate, 6-hydroxyhexyl (meth)acrylate, 8-hydroxyoctyl (meth)acrylate, 10-hydroxydecyl (meth)acrylate, 12-hydroxylauryl (meth)acrylate, and (4-hydroxymethylcyclohexyl)-methyl acrylate; carboxyl group-containing monomers such as (meth)acrylic acid, carboxyethyl (meth)acrylate, carboxypentyl (meth)acrylate, itaconic acid, maleic acid, fumaric acid, and crotonic acid; acid anhydride group-containing monomers such as maleic anhydride and itaconic anhydride; caprolactone adducts of acrylic acid; sulfonic acid group-containing monomers such as styrenesulfonic acid, allylsulfonic acid, 2-(meth)acrylamido-2-methylpropanesulfonic acid, (meth)acrylamidopropanesulfonic acid, sulfopropyl (meth)acrylate, and (meth)acryloyloxynaphthalenesulfonic acid; and phosphate group-containing monomers such as 2-hydroxyethylacryloyl phosphate.

Examples of such a monomer for modification also include (N-substituted) amide monomers such as (meth)acrylamide, N,N-dimethyl(meth)acrylamide, N-butyl(meth)acrylamide, N-methylol(meth)acrylamide, and N-methylolpropane(meth)acrylamide; alkylaminoalkyl (meth)acrylate monomers such as aminoethyl (meth)acrylate, N,N-dimethylaminoethyl (meth)acrylate, and tert-butylaminoethyl (meth)acrylate; alkoxyalkyl (meth)acrylate monomers such as methoxyethyl (meth)acrylate and ethoxyethyl (meth) acrylate; succinimide monomers such as N-(meth)acryloyloxymethylenesuccinimide, N-(meth)acryloyl-6-oxyhexamethylenesuccinimide, N-(meth)acryloyl-8-oxyoctamethylenesuccinimide, and N-acryloylmorpholine; maleimide monomers such as N-cyclohexylmaleimide, N-isopropylmaleimide, N-laurylmaleimide, and N-phenylmaleimide; and itaconimide monomers such as N-methylitaconimide, N-ethylitaconimide, N-butylitaconimide, N-octylitaconimide, N-2-ethylhexylitaconimide, N-cyclohexylitaconimide, and N-laurylitaconimide.

Examples of modification monomers that may also be used include vinyl monomers such as vinyl acetate, vinyl propionate, N-vinylpyrrolidone, methylvinylpyrrolidone, vinylpyridine, vinylpiperidone, vinylpyrimidine, vinylpiperazine, vinylpyrazine, vinylpyrrole, vinylimidazole, vinyloxazole, vinylmorpholine, N-vinylcarboxylic acid amides, styrene, α-methylstyrene, and N-vinylcaprolactam; cyanoacrylate monomers such as acrylonitrile and methacrylonitrile; epoxy group-containing acrylic monomers such as glycidyl (meth)acrylate; glycol acrylic ester monomers such as polyethylene glycol (meth)acrylate, polypropylene glycol (meth)acrylate, methoxyethylene glycol (meth)acrylate, and methoxypolypropylene glycol (meth)acrylate; and acrylate ester monomers such as tetrahydrofurfuryl (meth)acrylate, fluoro(meth)acrylate, silicone (meth)acrylate, and 2-methoxyethyl acrylate. Examples also include isoprene, butadiene, isobutylene, and vinyl ether.

Besides the above, a silicon atom-containing silane monomer may be exemplified as the copolymerizable monomer. Examples of the silane monomers include 3-acryloxypropyltriethoxysilane, vinyltrimethoxysilane, vinyltriethoxysilane, 4-vinylbutyltrimethoxysilane, 4-vinylbutyltriethoxysilane, 8-vinyloctyltrimethoxysilane, 8-vinyloctyltriethoxysilane, 10-methacryloyloxydecyltrimethoxysilane, 10-acryloyloxydecyltrimethoxysilane, 10-methacryloyloxydecyltriethoxysilane, and 10-acryloyloxydecyltriethoxysilane.

Copolymerizable monomers that may be used also include polyfunctional monomers having two or more unsaturated double bonds such as (meth)acryloyl groups or vinyl groups, which include (meth)acrylate esters of polyhydric alcohols, such as tripropylene glycol di(meth)acrylate, tetraethylene glycol di(meth)acrylate, 1,6-hexanediol di(meth)acrylate, bisphenol A diglycidyl ether di(meth)acrylate, neopentyl glycol di(meth)acrylate, trimethylolpropane tri(meth)acrylate, pentaerythritol tri(meth)acrylate, pentaerythritol tetra(meth)acrylate, dipentaerythritol penta(meth)acrylate, dipentaerythritol hexa(meth)acrylate, and caprolactone-modified dipentaerythritol hexa(meth)acrylate; and compounds having a polyester, epoxy or urethane skeleton to which two or more unsaturated double bonds are added in the form of functional groups such as (meth)acryloyl groups or vinyl groups in the same manner as the monomer component, such as polyester (meth)acrylates, epoxy (meth)acrylates and urethane (meth)acrylates.

Concerning the weight ratios of all monomer components, the alkyl (meth)acrylate should be a main component of the (meth)acrylic-based polymer, and the amount of the copolymerizable monomer used to form the (meth)acrylic-based polymer is preferably, but not limited to, 0 to about 20%, more preferably about 0.1 to about 15%, even more preferably about 0.1 to about 10%, based on the total weight of all monomer components.

Among these copolymerizable monomers, hydroxyl group-containing monomers or carboxyl group-containing monomers are preferably used in view of tackiness or durability. The hydroxyl group-containing monomer may be used in combination with the carboxyl group-containing monomer. When the pressure-sensitive adhesive composition contains a crosslinking agent, these copolymerizable monomers can serve as a reactive site with the crosslinking agent. Such hydroxyl group-containing monomers or carboxyl group-containing monomers are highly reactive with intermolecular crosslinking agents and therefore are preferably used to improve the cohesiveness or heat resistance of the resulting pressure-sensitive adhesive layer. Hydroxyl group-containing monomers are preferred in terms of reworkability, and carboxyl group-containing monomers are preferred in terms of achieving both durability and reworkability.

Among the above-mentioned copolymerizable monomers, the hydroxyl group-containing monomer is particularly preferable as an additive for forming the transparent resin layer when a compound having a primary or secondary amino group in the molecule, or a compound having a primary alcohol at the molecular terminal is used.

When a hydroxyl group-containing monomer is added as a copolymerizable monomer, its content is preferably from 0.01 to 15% by weight, more preferably from 0.03 to 10% by weight, even more preferably from 0.05 to 7% by weight. When a carboxyl group-containing monomer is added as a copolymerizable monomer, its content is preferably from 0.05 to 10% by weight, more preferably from 0.1 to 8% by weight, even more preferably from 0.2 to 6% by weight.

The (meth)acrylic-based polymer used generally has a weight average molecular weight in the range of 500,000 to 3,000,000. In view of durability, particularly in view of heat resistance, the weight average molecular weight of the polymer (A) used is preferably from 700,000 to 2,700,000, more preferably from 800,000 to 2,500,000. If the weight average molecular weight is less than 500,000, it is not preferred in view of heat resistance. If a weight average molecular weight is more than 3,000,000, it is not preferred because a large amount of a dilution solvent may be necessary for control of coating viscosity, which may increase cost. The weight average molecular weight refers to the value obtained by measurement by gel permeation chromatography (GPC) and conversion of the measured value into the polystyrene-equivalent value.

For the production of the (meth)acrylic-based polymer, any appropriate method may be selected from known production methods such as solution polymerization, bulk polymerization, emulsion polymerization, and various radical polymerization methods. The resulting (meth)acrylic-based polymer may be any type of copolymer such as a random copolymer, a block copolymer and a graft copolymer.

In a solution polymerization process, for example, ethyl acetate, toluene or the like is used as a polymerization solvent. In a specific solution polymerization process, for example, the reaction is performed under a stream of inert gas such as nitrogen at a temperature of about 50 to about 70° C. for about 5 to about 30 hours in the presence of a polymerization initiator.

Any appropriate polymerization initiator, chain transfer agent, emulsifying agent and so on may be selected and used for radical polymerization. The weight average molecular weight of the (meth)acrylic-based, polymer may be controlled by the reaction conditions including the amount of addition of the polymerization initiator or the chain transfer agent and monomers concentration. The amount, of the addition may be controlled as appropriate depending on the type of these materials.

Examples of the polymerization initiator include, but are not limited to, azo initiators such as 2,2′-azobisisobutylonitrile, 2,2′-azobis(2-amidinopropane)dihydrochloride, 2,2′-azobis[2-(5-methyl-2-imidazoline-2-yl)propane]dihydrochloride, 2,2′-azobis(2-methylpropionamidine)disulfate, 2,2′-azobis(N,N′-dimethyleneisobutylamidine), and 2,2′-azobis[N-(2-carboxyethyl)-2-methylpropionamidine]hydrate (VA-057, manufactured by Wako Pure Chemical Industries, Ltd.); persulfates such as potassium persulfate and ammonium persulfate; peroxide initiators such as di(2-ethylhexyl)peroxydicarbonate, di(4-tert-butylcyclohexyl)peroxydicarbonate, di-sec-butylperoxydicarbonate, tert-butylperoxyneodecanoate, tert-hexylperoxypivalate, tert-butylperoxypivalate, dilauroyl peroxide, di-n-octanoyl peroxide, 1,1,3,3-tetramethylbutylperoxy-2-ethyl hexanoate, di(4-methylbenzoyl) peroxide, dibenzoyl peroxide, tert-butylperoxyisobutylate, 1,1-di(tert-hexylperoxy)cyclohexane, tert-butylhydroperoxide, and hydrogen peroxide; and redox system initiators of a combination of a peroxide and a reducing agent, such as a combination of a persulfate and sodium hydrogen sulfite and a combination of a peroxide and sodium ascorbate.

One of the above polymerization initiators may be used alone, or two or more thereof may be used in a mixture. The total amount of the polymerization initiator is preferably from about 0.005 to 1 part by weight, more preferably from about 0.02 to about 0.5 parts by weight, based on 100 parts by weight of the monomer.

For example, when 2,2′-azobisisobutyronitrile is used as a polymerization initiator for the production of the (meth)acrylic-based polymer with the above weight average molecular weight, the polymerization initiator is preferably used in an amount of from about 0.06 to 0.2 parts by weight, more preferably of from about 0.08 to 0.175 parts by weight, based on 100 parts by weight of the total amount of the monomer components.

Examples of the chain transfer agent include lauryl mercaptan, glycidyl mercaptan, mercaptoacetic acid, 2-mercaptoethanol, thioglycolic acid, 2-ethylhexyl thioglycolate, and 2,3-dimercapto-1-propanol. One of these chain transfer agents may be used alone, or two or more thereof may be used in a mixture. The total amount of the chain transfer agent is preferably 0.1 parts by weight or less, based on 100 parts by weight of the total amount of the monomer components.

Examples of the emulsifier used in emulsion polymerization include anionic emulsifiers such as sodium lauryl sulfate, ammonium lauryl sulfate, sodium dodecylbenzenesulfonate, ammonium polyoxyethylene alkyl ether sulfate, and sodium polyoxyethylene alkyl phenyl ether sulfate; and nonionic emulsifiers such as polyoxyethylene alkyl ether, polyoxyethylene alkyl phenyl ether, polyoxyethylene fatty acid ester, and polyoxyethylene-polyoxypropylene block polymers. These emulsifiers may be used alone, or two or more thereof may be used in combination.

The emulsifier may be a reactive emulsifier. Examples of such an emulsifier having an introduced radical-polymerizable functional group such as a propenyl group and an allyl ether group include Aqualon HS-10, HS-20, KH-10, BC-05, BC-10, and BC-20 (each manufactured by Dai-ichi Kogyo Seiyaku Co., Ltd.) and Adekaria Soap SE10N (manufactured by Asahi Denka Kogyo K.K.). The reactive emulsifier is preferred, because after polymerization, it can be incorporated into a polymer chain to improve water resistance. Based on 100 parts by weight of the total monomer component, the emulsifier is preferably used in an amount of 0.3 to 5 parts by weight, more preferably of 0.5 to 1 parts by weight, in view of polymerization stability or mechanical stability.

The pressure-sensitive adhesive composition according to the invention contains the alkali metal salt in addition to the (meth)acrylic-based polymer.

[Alkali Metal Salt]

Any of organic and inorganic salts of alkali metals may be used as the alkali metal salt.

The cation moiety of the alkali metal salt includes an alkali metal ion, which may be any of lithium, sodium, and potassium ions. Among these alkali metal ions, lithium ion is particularly preferred.

The anion moiety of the alkali metal salt may include an organic material or an inorganic material. Examples of the anion moiety that may be used to form the organic salt include CH₃COO⁻, CF₃COO⁻, CH₃SO₃⁻, CF₃SO₃⁻, (CF₃SO₂)₃C⁻, C₄F₉SO₃⁻, C₃F₇COO⁻, (CF₃SO₂) (CF₃CO)N⁻, ⁻O₃S(CF₂)₃SO₃⁻, PF₆⁻, and CO₃²⁻, and those represented by the following general formulae (1) to (4):
(1) (CₙF₂ₙ₊₁SO₂)₂N⁻, wherein n is an integer of 1 to 10;
(2) CF₂(CₘF₂ₘSO₂)₂N⁻, wherein m is an integer of 1 to 10;
(3) ⁻O₃S(CF₂)ₗSO₃⁻, wherein l is an integer of 1 to 10; and
(4) (CₚF₂ₚ₊₁SO₂)N⁻(C_{q}F_{2q+1}SO₂), wherein p and q are each an integer of 1 to 10. In particular, a fluorine atom-containing anion moiety is preferably used because it can form an ionic compound with good ionic dissociation properties. Examples of the anion moiety that may be used to form the inorganic salt include Cl⁻, Br⁻, I⁻, AlCl₄⁻, Al₂Cl₇⁻, BF₄⁻, PF₆⁻, ClO₄⁻, NO₃⁻, AsF₆⁻, SbF₆⁻, NbF₆⁻, TaF₆⁻, and (CN)₂N⁻. The anion moiety is preferably (perfluoroalkylsulfonyl)imide represented by the general formula (1), such as (CF₃SO₂)₂N⁻ or (C₂F₅SO₂)₂N⁻, in particular, preferably (trifluoromethanesulfonyl)imide such as (CF₃SO₂)₂N⁻.

Examples of organic salts of alkali metals include sodium acetate, sodium alginate, sodium lignosulfonate, sodium toluenesulfonate, LiCF₃SO₃, Li(CF₃SO₂)₂N, Li(CF₃SO₂)₂N, Li(C₂F₅SO₂)₂N, Li(C₄F₉SO₂)₂N, Li(CF₃SO₂)₃C, KO₃S(CF₂)₃SO₃K, and LiO₃S(CF₂)₃SO₃K. Among them, LiCF₃SO₃, Li(CF₃SO₂)₂N, Li(C₂F₅SO₂)₂N, Li(C₄F₉SO₂)₂N, Li(CF₃SO₂)₃C, and the like are preferred, fluorine-containing lithium imide salts such as Li(CF₃SO₂)₂N, Li(C₂F₅SO₂)₂N, and Li(C₄F₉SO₂)₂N are more preferred, and a (perfluoroalkylsulfonyl)imide lithium salt is particularly preferred.

Examples of inorganic salts of alkali metals include lithium perchlorate and lithium iodide.

From the viewpoint of the antistatic function, the proportion of the alkali metal salt in the pressure-sensitive adhesive composition of the present invention is 0.1 parts by weight or more with respect to 100 parts by weight of the base polymer (for example, (meth)acrylic-based polymer). The alkali metal salt is preferably 0.5 parts by weight or more, more preferably 1 part by weight or more, even more preferably 5 parts by weight or more. On the other hand, the alkali metal salt is preferably 10 parts by weight or less because there are cases where the effect of improving the antistatic performance after the humidification test under severe conditions is not sufficient.

The pressure-sensitive adhesive composition of the invention also includes a crosslinking agent. An organic crosslinking agent or a polyfunctional metal chelate may also be used as the crosslinking agent. Examples of the organic crosslinking agent include an isocyanate crosslinking agent, an epoxy crosslinking agent, a peroxide crosslinking agent and an imine crosslinking agents. The polyfunctional metal chelate may include a polyvalent metal and an organic compound that is covalently or coordinately bonded to the metal. Examples of the polyvalent metal atom include Al, Cr, Zr, Co, Cu, Fe, Ni, V, Zn, In, Ca, Mg, Mn, Y, Ce, Sr, Ba, Mo, La, Sn, and Ti. The organic compound has a covalent or coordinate bond-forming atom such as an oxygen atom. Examples of the organic compound include alkyl esters, alcohol compounds, carboxylic acid compounds, ether compounds, and ketone compounds.

The crosslinking agent to be used is preferably selected from an isocyanate crosslinking agent and/or a peroxide crosslinking agent. Examples of such a compound for the isocyanate crosslinking agent include isocyanate monomers such as tolylene diisocyanate, chlorophenylene diisocyanate, tetramethylene diisocyanate, xylylene diisocyanate, diphenylmethane diisocyanate, and hydrogenated diphenylmethane diisocyanate, and isocyanate compounds produced by adding any of these isocyanate monomers to trimethylolpropane or the like; and urethane prepolymer type isocyanates produced by the addition reaction of isocyanurate compounds, burette type compounds, or polyether polyols, polyester polyols, acrylic polyols, polybutadiene polyols, polyisoprene polyols, or the like. Particularly preferred is a polyisocyanate compound such as one selected from the group consisting of hexamethylene diisocyanate, hydrogenated xylylene diisocyanate, and isophorone diisocyanate, or a derivative thereof. Examples of one selected from the group consisting of hexamethylene diisocyanate, hydrogenated xylylene diisocyanate, and isophorone diisocyanate, or a derivative thereof include hexamethylene diisocyanate, hydrogenated xylylene diisocyanate, isophorone diisocyanate, polyol-modified hexamethylene diisocyanate, polyol-modified hydrogenated xylylene diisocyanate, trimer-type hydrogenated xylylene diisocyanate, and polyol-modified isophorone diisocyanate. The listed polyisocyanate compounds are preferred, because their reaction with a hydroxyl group quickly proceeds as if an acid or a base contained in the polymer acts as a catalyst, which particularly contributes to the rapidness of the crosslinking.

As the crosslinking agent, an isocyanate-based crosslinking agent (isocyanate-based compound) is preferable as an additive for forming the transparent resin layer when a compound having a primary or secondary amino group in the molecule or a compound having at least one primary alcohol at the molecular terminal is used.

Any peroxide capable of generating active radical species by heating or photoirradiation and promoting the crosslinking of the base polymer in the pressure-sensitive adhesive composition may be appropriately used. In view of workability and stability, a peroxide with a one-minute half-life temperature of 80° C. to 160° C. is preferably used, and a peroxide with a one-minute half-life temperature of 90° C. to 140° C. is more preferably used.

Examples of the peroxide for use in the invention include di(2-ethylhexyl) peroxydicarbonate (one-minute half-life temperature: 90.6° C.), di(4-tert-butylcyclohexyl) peroxydicarbonate (one-minute half-life temperature: 92.1° C.), di-sec-butyl peroxydicarbonate (one-minute half-life temperature: 92.4° C.), tert-butyl peroxyneodecanoate (one-minute half-life temperature: 103.5° C.), tert-hexyl peroxypivalate (one-minute half-life temperature: 109.1° C.), tert-butyl peroxypivalate (one-minute half-life temperature: 110.3° C.), dilauroyl peroxide (one-minute half-life temperature: 116.4° C.), di-n-octanoylperoxide (one-minute half-life temperature: 117.4° C.), 1,1,3,3-tetramethylbutylperoxy-2-ethyl hexanoate (one-minute half-life temperature: 124.3° C.), di (4-methylbenzoyl) peroxide (one-minute half-life temperature: 128.2° C.), dibenzoyl peroxide (one-minute half-life temperature: 130.0° C.), tert-butyl peroxyisobutylate (one-minute half-life temperature: 136.1° C.), and 1,1-di(tert-hexylperoxy)cyclohexane (one-minute half-life temperature: 149.2° C.). In particular, di(4-tert-butylcyclohexyl) peroxydicarbonate (one-minute half-life temperature: 92.1° C.), dilauroyl peroxide (one-minute half-life temperature: 116.4° C.), dibenzoyl peroxide (one-minute half-life temperature: 130.0° C.), or the like is preferably used, because they can provide high crosslinking reaction efficiency.

The half life of the peroxide is an indicator of how fast the peroxide can be decomposed and refers to the time required for the amount of the peroxide to reach one half of its original value. The decomposition temperature required for a certain half life and the half life time obtained at a certain temperature are shown in catalogs furnished by manufacturers, such as “Organic Peroxide Catalog, 9th Edition, May, 2003” furnished by NOF CORPORATION.

The amount of the crosslinking agent to be used is preferably from 0.01 to 20 parts by weight, more preferably from 0.03 to 10 parts by weight, based on 100 parts by weight of the (meth)acrylic-based polymer. If the amount of the crosslinking agent is less than 0.01 parts by weight, the cohesive strength of the pressure-sensitive adhesive may tend to be insufficient, and foaming may occur during heating. If the amount of the crosslinking agent is more than 20 parts by weight, the humidity resistance may be insufficient, so that peeling may easily occur in a reliability test or the like.

One of the isocyanate-based crosslinking agents may be used alone, or a mixture of two or more of the isocyanate-based crosslinking agents may be used. The total amount of the polyisocyanate compound crosslinking agent(s) is preferably from 0.01 to 2 parts by weight, more preferably from 0.02 to 2 parts by weight, even more preferably from 0.05 to 1.5 parts by weight, based on 100 parts by weight of the (meth)acrylic-based polymer. The content may be appropriately controlled taking into account the cohesive strength or the prevention of peeling in a durability test or the like.

One of the peroxide crosslinking agents may be used alone, or a mixture of two or more of the peroxide crosslinking agent may be used. The total amount of the peroxide(s) is preferably from 0.01 to 2 parts by weight, more preferably from 0.04 to 1.5 parts by weight, even more preferably from 0.05 to 1 part by weight, based on 100 parts by weight of the (meth)acrylic-based polymer. The amount of the peroxide(s) may be appropriately selected in this range in order to control the workability, reworkability, crosslink stability or peeling properties.

The amount of decomposition of the peroxide may be determined by measuring the peroxide residue after the reaction process by high performance liquid chromatography (HPLC).

More specifically, for example, after the reaction process, about 0.2 g of each pressure-sensitive adhesive composition is taken out, immersed in 10 ml of ethyl acetate, subjected to shaking extraction at 25° C. and 120 rpm for 3 hours in a shaker, and then allowed to stand at room temperature for 3 days. Thereafter, 10 ml of acetonitrile is added, and the mixture is shaken at 25° C. and 120 rpm for 30 minutes. About 10 μl of the liquid extract obtained by filtration through a membrane filter (0.45 μm) is subjected to HPLC by injection and analyzed so that the amount of the peroxide after the reaction process is determined.

The pressure-sensitive adhesive composition of the invention may further contain a silane coupling agent (D). The durability or the reworkability can be improved using the silane coupling agent (D). Examples of silane coupling agent include epoxy group-containing silane coupling agents such as 3-glycidoxypropyltrimethoxysilane, 3-glycidoxypropyltriethoxysilane, 3-glycidoxypropylmethyldiethoxysilane, and 2-(3,4-epoxycyclohexyl)ethyltrimethoxysilane; amino group-containing silane coupling agents such as 3-aminopropyltrimethoxysilane, N-(2-aminoethyl)-3-aminopropylmethyldimethoxysilane, and 3-triethoxysilyl-N-(1,3-dimethylbutylidene)propylaxaine; (meth)acrylic group-containing silane coupling agents such as 3-acryloxypropyltrimethoxysilane and 3-methacryloxypropyltriethoxysilane; and isocyanate group-containing silane coupling agents such as 3-isocyanatepropyltriethoxysilane.

One of the silane coupling agents (D) may be used alone, or a mixture of two or more of the silane coupling agents. The total amount of the silane coupling agent(s) is preferably from 0.001 to 5 parts by weight, more preferably from 0.01 to 1 part by weight, even more preferably from 0.02 to 1 part by weight, still more preferably from 0.05 to 0.6 parts by weight, based on 100 parts by weight of the (meth)acrylic-based polymer. The amount of the silane coupling agent may be appropriately amount in order to control improve durability and maintain adhesive strength to the optical member such as a liquid crystal cell.

The pressure-sensitive adhesive composition according to the invention may further contain a polyether-modified silicone compound. The polyether-modified silicone compound may be for example, that disclosed in JP-A-2010-275522.

The polyether-modified silicone compound has a polyether skeleton and a reactive silyl group represented by formula (1): —SiRₐM₃₋ₐ at at least one terminal, wherein R represents a monovalent organic group having 1 to 20 carbon atoms and optionally having a substituent; M represents a hydroxyl group or a hydrolyzable group, and <a> represents an integer of 0 to 2, provided that in cases where two or more R groups, R groups is the same or different, and in cases where two or more M groups, M groups is the same or different.

The polyether-modified silicone compound may be a compound represented by formula (2): RₐM₃₋ₐSi—X—Y—(AO)ₙ—Z, wherein R represents a monovalent organic group having 1 to 20 carbon atoms and optionally having a substituent, M represents a hydroxyl group or a hydrolyzable group; <a> represents an integer of 0 to 2, provided that in cases where two or more R groups, R groups is the same or different, and in cases where two or more M groups, M groups is the same or different, AO represents a straight- or branched-chain oxyalkylene group of 1 to 10 carbon atoms, n represents the average addition molar number of the oxyalkylene groups, which is front 1 to 1,700; X represents a straight- or branched-chain alkylene group of 1 to 20 carbon atoms, Y represents an ether bond, an ester bond, a urethane bond, or a carbonate bond and

Z represents a hydrogen atom, a monovalent hydrocarbon group of 1 to 10 carbon atoms,

a group represented by formula (2A): —Y¹—X—SiRₐM₃₋ₐ, wherein R, M and X have the same meanings as defined above; and Y¹ represents a single bond, a —CO— bond, a —CONH— bond, or a —COO— bond, or

a group represented by formula (2B):

-Q{-(OA)ₙ-Y—X—SiRₐM₃₋ₐ}ₘ,

wherein R, M, X, and Y have the same meanings as defined above, OA has the same meaning as AO defined above, n has the same meaning as defined above, Q represents a divalent or polyvalent hydrocarbon group of 1 to 10 carbon atoms, and m represents a number that is the same as the valence of the hydrocarbon group.

Specific examples of the polyether-modified silicone compound include MS Polymers S203, S303 and S810 manufactured by Kaneka Corporation; SILYL EST250 and EST280 manufactured by Kaneka Corporation; SAT10, SAT200, SAT220, SAT350, and SAT400 manufactured by Kaneka Corporation; and EXCESTAR S2410, S2420 or S3430 manufacture by ASAHI GLASS CO., LTD.

The pressure-sensitive adhesive composition of the invention may also contain any other known additive. For example, a polyether compound of a polyalkylene glycol such as polypropylene glycol, a powder such as a colorant and a pigment, a tackifier, a dye, a surfactant, a plasticizer, a surface lubricant, a leveling agent, a softening agent, an antioxidant, an age resister, a light stabilizer, an ultraviolet absorbing agent, a polymerization inhibitor, an inorganic or organic filler, a metal powder, or a particle- or foil-shaped material may be added as appropriate depending on the intended use. A redox system including an added reducing agent may also be used in the controllable range.

The pressure-sensitive adhesive composition is used to form a pressure-sensitive adhesive layer. To form the pressure-sensitive adhesive layer, it is preferred that the total amount of the addition of the crosslinking agent should be controlled and that the effect of the crosslinking temperature and the crosslinking time should be carefully taken into account.

The crosslinking temperature and the crosslinking time may be controlled depending on the crosslinking agent used. The crosslinking temperature is preferably 170° C. or less.

The crosslinking process may be performed at the temperature of the process of drying the pressure-sensitive adhesive layer, or the crosslinking process may be separately performed, after the drying process.

The cross linking time is generally from about 0.2 to about 20 minutes, preferably from about 0.5 to about 10 minutes, while it may be set taking into account productivity and workability.

As a method for forming the pressure-sensitive adhesive layer, for example, the adhesive layer is formed by a method in which the pressure-sensitive adhesive composition is applied to a release-treated separator or the like and transferred to the transparent resin layer after the formation of the pressure sensitive adhesive layer by removing the polymerization solvent, through drying, as in the embodiments of FIGS. 1 and 2. Alternatively, in the embodiments of FIGS. 1 and 2, the pressure-sensitive adhesive composition is applied to the transparent resin layer, and the polymerisation solvent and the like are removed by drying to form the pressure-sensitive adhesive layer on the polarizing film. In applying the pressure-sensitive adhesive, one or more solvents other than the polymerization solvent may be newly added, as appropriate.

A silicone release liner is preferably used as the release-treated separator. The pressure-sensitive adhesive composition of the invention may be applied to such a liner and dried to form a pressure-sensitive adhesive layer. In this process, the pressure-sensitive adhesive composition may be dried using any appropriate method depending on the purpose. A method of drying by heating the coating film is preferably used. The heat drying temperature is preferably from 40° C. to 200° C., more preferably from 50° C. to 180° C., particularly preferably from 70° C. to 170° C. When the heating temperature is set in the above range, a pressure-sensitive adhesive layer having good adhesive properties can be obtained.

Any appropriate drying time may be used. The drying time is preferably from 5 seconds to 20 minutes, more preferably from 5 seconds to 10 minutes, particularly preferably from 10 seconds to 5 minutes.

Various methods may be used to form the pressure-sensitive adhesive layer. Specific examples of such methods include roll coating, kiss roll coating, gravure coating, reverse coating, roll brush coating, spray coating, dip roll coating, bar coating, knife coating, air knife coating, curtain coating, lip coating, and extrusion coating with a die coater or the like.

The thickness of the pressure-sensitive adhesive layer is typically, but not limited to, from about 1 to 100 μm, preferably from 2 to 50 μm, more preferably from 2 to 40 μm, further preferably from 5 to 35 μm.

When the pressure-sensitive adhesive layer is exposed, the pressure-sensitive adhesive layer may be protected with a sheet having undergone release treatment (a separator) before practical use.

Examples of the material for forming the separator include a plastic film such as a polyethylene, polypropylene, polyethylene terephthalate, or polyester film, a porous material such as paper, cloth and nonwoven fabric, and an appropriate thin material such as a net, a foamed sheet, a metal foil, and a laminate thereof. In particular, a plastic film is preferably used, because of its good surface smoothness.

The plastic film may be any film capable of protecting the pressure-sensitive adhesive layer, and examples thereof include a polyethylene film, a polypropylene film, a polybutene film, a polybutadiene film, a polymethylpentene film, a polyvinyl chloride film, a vinyl chloride copolymer film, a polyethylene terephthalate film, a polybutylene terephthalate film, a polyurethane film, and an ethylene-vinyl acetate copolymer film.

The thickness of the separator is generally from about 5 to about 200 μm, preferably from about 5 to about 100 μm. If necessary, the separator may be treated, with a release agent such as a silicone, fluorine, long-chain alkyl, or fatty acid amide release agent, or may be subjected to release and antifouling treatment with silica powder or to antistatic treatment of coating type, kneading and mixing type, vapor-deposition type, or the like. In particular, if the surface of the separator is appropriately subjected to release treatment such as silicone treatment, long-chain alkyl treatment, and fluorine treatment, the releasability from the pressure-sensitive adhesive layer can be further increased.

In the above production method, the release-treated sheet may be used without modification as a separator for the pressure-sensitive-adhesive-layer-attached polarizing film, so that the process can be simplified.

<Surface Protective Film>

A surface protective film may be provided on the pressure-sensitive-adhesive-layer-attached polarizing film. The surface protective film generally has a base film and a pressure-sensitive adhesive layer. The surface protective film protects the polarizer with the pressure-sensitive adhesive layer interposed between them.

In view of the ability to be tested or managed, an isotropic or nearly-isotropic film material should be selected as the base film for the surface protective film. Examples of such a film material include polyester-based resins such as polyethylene terephthalate films, cellulose-based resins, acetate-based resins, polyethersulfone-based resins, polycarbonate-based resins, polyamide-based resins, polyimide-based resins, polyolefin-based resins, acryl-based resins, and other transparent polymers. In particular, polyester-based resins are preferred. The base film may be made of a single film material or a laminate of two or more film materials. The base film may also be a product obtained by stretching the film. The base film generally has a thickness of 500 μm or less, preferably 10 to 200 μm.

The pressure-sensitive adhesive used to form the pressure-sensitive adhesive layer for the surface protective film may be appropriately selected from pressure-sensitive adhesives including, as a base polymer, a (meth)acrylic-based polymer, a silicone-based polymer, polyester, polyurethane, polyamide, polyether, fluoride-based polymer, rubber-based polymer, or any other polymer. An acryl-based pressure-sensitive adhesive containing an acrylic-based polymer as a base polymer is preferred in view of transparency, weather resistance, heat resistance, and other properties. The thickness (dry thickness) of the pressure-sensitive adhesive layer is selected depending on the desired adhesive strength. The thickness of the pressure-sensitive adhesive is generally from about 1 to about 100 μm, preferably from 5 to 50 μm.

A silicone, long-chain alkyl, or fluorine treatment with a low-adhesion material may also be performed to form a release treatment layer on the surface of the base film of the surface protective film, opposite to its surface on which the pressure-sensitive adhesive layer is provided.

<Other Optical Layers>

For practical use, the pressure-sensitive-adhesive-layer-attached polarizing film of the invention may be laminated with any other optical layer or layers to form an optical film. As a non-limiting example, such an optical layer or layers may be one or more optical layers that have ever been used to form liquid crystal display devices or other devices, such as a reflector, a transflector, a retardation plate (including a wavelength plate such as a half or quarter wavelength plate), or a viewing angle compensation film. Particularly preferred is a reflective or transflective polarizing film including a laminate of the pressure-sensitive-adhesive-layer-attached polarizing film of the invention and a reflector or a transflector, an elliptically or circularly polarizing film including a laminate of the polarizing film of the invention and a retardation plate, a wide viewing angle polarizing film including a laminate of the polarizing film of the invention and a viewing angle compensation film, or a polarizing film including a laminate of the polarizing film of the invention and a brightness enhancement film.

The optical film including a laminate of the above optical layer and the pressure-sensitive-adhesive-layer-attached polarizing film may be formed by a method of stacking them one by one, for example, in the process of manufacturing a liquid crystal display device. However, the optical film should be formed by stacking them in advance, which is superior in quality stability or assembling workability and thus advantageous in facilitating the process of manufacturing liquid crystal display devices or other devices. In the lamination, any appropriate bonding means such as a pressure-sensitive adhesive layer may be used. When the pressure-sensitive-adhesive-layer-attached polarizing film and any other optical film are bonded together, their optical axes may be each aligned at an appropriate angle, depending on the desired retardation properties or other desired properties.

The pressure-sensitive-adhesive-layer-attached polarizing film or the optical film according to the invention is preferably used to form various devices such as liquid crystal display devices or the like. Liquid crystal display devices may be formed according to conventional techniques. Specifically, a liquid crystal display device may be typically formed according to any conventional techniques by appropriately assembling a liquid crystal cell, pressure-sensitive-adhesive-layer-attached polarizing films or optical films, and optional components such as a lighting system, incorporating a driving circuit, and performing other processes, except that the pressure-sensitive-adhesive-layer-attached polarizing film or the optical film according to the invention is used. The liquid crystal cell to be used may also be of any type, such as IPS type or VA type.

Any desired liquid crystal display device may be formed, such as a liquid crystal display device including a liquid crystal cell and the pressure-sensitive-adhesive-layer-attached polarizing film or films, or the optical film or films placed on one or both sides of the liquid crystal cell, or a liquid crystal display device further including a backlight or a reflector in the lighting system. In such a case, the pressure-sensitive-adhesive-layer-attached polarizing film or films or the optical film or films according to the invention may be placed on one or both sides of the liquid crystal cell. When the pressure-sensitive-adhesive-layer-attached polarizing films or the optical films are provided on both sides, they may be the same or different. The process of forming the liquid crystal display device may also include placing, at an appropriate position or positions, one or more layers of an appropriate component such as a diffusion plate, an antiglare layer, an anti-reflection film, a protective plate, a prism array, a lens array sheet, a light diffusion plate, or a backlight.

### EXAMPLES

Hereinafter, the invention will be more specifically described with reference to examples. It will be understood that the examples shown below are not intended to limit the invention. In each example, “parts” and “%” are all by weight. Unless otherwise specified below, the conditions of standing at room temperature include 23° C. and 65% RH in all cases.

<Measurement of Weight Average Molecular Weight of (Meth)Acrylic-based Polymer>

The weight average molecular weight (Mw) of the (meth)acrylic-based polymer was measured by GPC (Gel Permeation Chromatography).
Analyzer: HLC-8120GPC manufactured by TOSOH CORPORATION
Columns: G7000H_{XL}+GMH_{XL}+GMH_{XL} manufactured by TOSOH CORPORATION
Column size: each 7.8 mmφ×30 cm, 90 cm in total
Colum temperature: 40° C
Flow rate: 0.8 ml/minute
Injection volume: 100 μl
Fluent: tetrahydrofuran
Detector: differential refractometer (RI)
Standard sample: polystyrene

<Preparation of Polarizer>

A corona treatment was performed on one surface of an amorphous isophthalic acid-copolymerized polyethylene terephthalate (IPA-copolymerized PET) film substrate (100 μm in thickness) with a water absorption of 0.75% and a Tg of 75° C. An aqueous solution containing polyvinyl alcohol (4,200 in polymerization degree, 99.2% by mole in saponification degree) and acetoacetyl-modified PVA (Gohsefimer Z200 (trade name) manufactured by The Nippon Synthetic Chemical Industry Co., Ltd., 1,200 in polymerization degree, 4.6% in acetoacetyl modification degree, 99.0% by mole or more in saponification degree) in a ratio of 9:1 was applied to the corona-treated surface at 25° C. and then dried to form a 11-μm-thick PVA-based resin layer, so that a laminate was formed.

In an oven at 120° C., the resulting laminate was subjected to free-end uniaxial stretching to 2.0 times in the longitudinal direction between rolls at different peripheral speeds (auxiliary in-air stretching).

Subsequently, the laminate was immersed in an insolubilization bath (an aqueous boric acid solution obtained by adding 4 parts by weight of boric acid to 100 parts by weight of water) at a temperature of 30° C. for 30 seconds (insolubilization).

Subsequently, the laminate was immersed in a dyeing bath at a temperature of 30° C. while the iodine concentration and the immersion time were so controlled as to allow the resulting polarizing plate to have a predetermined transmittance. In this example, the laminate was immersed for 60 seconds in an aqueous iodine solution obtained by adding 0.2 parts by weight of iodine and 1.0 part by weight of potassium iodide to 100 parts by weight of water (dyeing).

Subsequently, the laminate was immersed for 30 seconds in a crosslinking bath (an aqueous boric acid solution obtained by adding 3 parts by weight of potassium iodide and 3 parts by weight of boric acid to 100 parts by weight of water) at a temperature of 30° C. (crosslinking).

The laminate was then uniaxially stretched to a total stretch ratio of 5.5 times in the longitudinal direction between rolls at different peripheral speeds while it was immersed in an aqueous boric acid solution (an aqueous solution obtained by adding 4 parts by weight of boric acid and 5 parts by weight of potassium iodide to 100 parts by weight of water) at a temperature of 70° C. (in-water stretching).

The laminate was then immersed in a cleaning bath (an aqueous solution obtained by adding 4 parts by weight of potassium iodide to 100 parts by weight of water) at a temperature of 30° C. (cleaning).

The resulting product was an optical film laminate including a 5-μm-thick polarizer.

(Preparation of Protective Film)

The adhesion facilitation-treated surface of a lactone ring structure-containing (meth)acrylic resin film with a thickness of 40 μm was subjected to a corona treatment. The corona-treated film was used as a protective film.

(Preparation of Adhesive to be Applied to Protective Film)

An ultraviolet-curable adhesive was prepared by mixing 40 parts by weight of N-hydroxyethylacrylamide (HEAA), 60 parts by weight of acryloylmorpholine (ACMO), and 3 parts by weight of a photo-initiator IRGACURE 819 (manufactured by BASF).

<Preparation of One-Side-Protected Polarizing Film>

The protective film was bonded to the surface of the polarizing film of optical film laminate with the ultraviolet-curable adhesive being applied to the surface in such a manner as to form a 0.5-μm-thick adhesive layer after curing. Subsequently, the adhesive was cured by the ultraviolet ray as the active energy ray irradiation. A gallium-sealed metal halide lamp (manufactured by Fusion UV Systems, Inc., tradename: “Light HAMMER 10”, bulb: V bulb) was used as an irradiation apparatus in the irradiation with the UV ray, and the irradiation was performed under the conditions of a peak illuminance of 1600 mW/cm² and a cumulative irradiation dose of 1000/mJ/cm² (wavelength: 380 to 440 nm). The illuminance of the UV ray was measured with a Sola-Check System manufactured by Solatell Ltd. Subsequently, the amorphous PET substrate was removed, so that one-side-protected polarizing film having the thin polarizing film was obtained. The optical properties of resulting one-side-protected polarizing film were as follows: transmittance 42.8%, polarization degree 99.99%.

<Layer-Forming Material for Transparent, Resin Layer: Polyvinyl Alcohol-Based Resin Composition>

100 parts of a polyvinyl alcohol-based resin having a polymerization degree of 2500 and a saponification degree of 99.7 mol % and 5 parts of methylol melamine (manufactured by DIG Corporation, trade name “Water Sol: S-695”) as an additive were dissolved in pure water to prepare an aqueous solution having a solid content concentration of 4% by weight.

<Preparation of Acrylic-Based Polymer>

A monomer mixture including 99 parts of butyl acrylate and 1 part of 4-hydroxybutyl acrylate was added to a four-necked flask equipped with a stirring blade, a thermometer, a nitrogen gas inlet tube, and a condenser. On the basis of 100 parts (solids) of the monomer mixture, 0.1 parts of 2,2′-azobisisobutyronitrile as a polymerization initiator was further added together with ethyl acetate to the flask. While the mixture was gently stirred, nitrogen gas was introduced to replace the air in the flask. Subsequently, the mixture was subjected to polymerization reaction for 7 hours while the temperature of the liquid in the flask was maintained at around 60° C. Subsequently, ethyl acetate was added to the resulting reaction liquid, so that a solution of an acrylic-based polymer with a weight average molecular weight of 1,400,000 was obtained with an adjusted solid concentration of 30%.

(Preparation of Pressure-Sensitive Adhesive Composition)

Based on 100 parts of the solids of the acrylic-based polymer solution, 0.2 parts of ethylmethylpyrrolidinium bis(trifluoromethanesulfonyl)imide (manufactured by Tokyo Chemical Industry Co., Ltd.), 1 parts of lithium bis(trifluoromethanesulfonyl)imide (manufactured by Mitsubishi Materials Electronic Chemicals Co., Ltd), 0.1 parts of trimethylolpropane xylylene diisocyanate (Takenate D110N, manufactured by Mitsui Chemicals, Inc.), 0.3 parts of dibenzoyl peroxide, and 0.075 parts of γ-glycidoxypropylmethoxysilane (KBM-403, manufactured by Shin-Etsu Chemical Co., Ltd.) were added to the acrylic-based polymer solution, so that an acrylic-based pressure-sensitive adhesive solution was obtained.

(Preparation of Pressure-Sensitive-Adhesive-Layer-Attached Polarizing Film)

Subsequently, the acrylic-based pressure-sensitive adhesive solution was uniformly applied to the surface of a silicone release agent-treated polyethylene terephthalate film (separator film) with a fountain coater, and dried for 2 minutes in an air circulation-type thermostatic oven at 155° C., so that a 20 μm thick pressure-sensitive adhesive layer was formed on the surface of the separator film.

### Example 1

<Preparation of Transparent-Resin-Layer-Attached One-Side Protected Polarizing Film>

On the surface (polarizer surface not provided with a protective film) of the polarizing film (polarizer) of the one-side protected polarizing film, the polyvinyl alcohol-based resin composition adjusted to 25° C. was applied with a wire bar coater to form a film having a thickness of 1 μm after drying. Then, the film was dried with hot air at 60° C. for 1 minute to prepare a transparent-resin-layer-attached one-side protected polarizing film.

<Preparation of Pressure-Sensitive-Adhesive-Layer-Attached Polarizing Film>

Subsequently, the pressure-sensitive adhesive layer formed on the release-treated surface of the release sheet (separator) was bonded to the transparent resin layer formed on the one-side protected polarizing film to prepare a pressure-sensitive-adhesive-layer-attached polarizing film.

### Examples 2 to 11 and Comparative Examples 1 to 4

A transparent-resin-layer-attached one-side protected polarizing film and a pressure-sensitive-adhesive-layer-attached polarizing film were prepared in the same manner as in Example 1, except that the thickness of the transparent resin layer, the kind of the polyvinyl alcohol-based resin, the kind and amount of the additive (the amount of the additive is a value with respect to 100 parts of the polyvinyl alcohol-based resin), and the amount of the alkali metal salt in the pressure-sensitive adhesive composition (the amount was a value with respect to 100 parts of the acrylic-based polymer) in Example 1 were changed as shown in Table 1.

The pressure-sensitive-adhesive-layer-attached polarizing film obtained in each of the examples and the comparative examples was evaluated as described below. The results of the evaluation are shown in Table 1.

<Measurement of the Content of Boric Acid in Polarizer>

The polarizers obtained in the examples and the comparative examples were subjected to attenuated total reflection (ATR) spectroscopy using polarized light as the measurement light and using a Fourier transform infrared spectrometer (FTIR) (Spectrum 2000 (trade name) manufactured by PerkinElmer, Inc.), in which the boric acid peak (665 cm⁻¹) intensity and the reference peak (2,941 cm⁻¹) intensity were measured. The boric acid amount index was calculated from the formula below using the resulting boric acid peak intensity and reference peak intensity, and then the boric acid content (% by weight) was determined from the formula below using the calculated boric acid amount index.

(Boric acid amount index)=(the intensity of the boric acid peak at 665 cm⁻¹)/(the intensity of the reference peak at 2,941 cm⁻¹)

(Boric acid content (% by weight))=(boric acid amount index)×5.54+4.1

<Abundance Ratio of Alkali Metal Salt>

The resulting pressure-sensitive-adhesive-layer-attached polarizing film was immersed in liquid nitrogen for 1 minute to be frozen, and then cut from the pressure-sensitive adhesive layer side toward the transparent resin layer to obtain a sample. Using the time-of-flight secondary ion mass spectrometer (TOF-SIMS) (tradename “TOF-SIMS 5”, manufactured by ION-TOF GmbH), the sample was measured for the distribution of the lithium ion intensity in the cross section of the pressure-sensitive adhesive layer from the transparent resin layer, thereby to obtain a graph as shown in FIG. 3. The measurement conditions are shown below.

Primary ion: Bi₃²⁺

Primary ion acceleration voltage: 25 kV

Measurement area: 500 μm square

Measurement temperature: −100° C. or less

The ion intensity X of Li⁺ at the center part in the thickness direction of the pressure-sensitive adhesive layer of the obtained graph was obtained. X of Example 1 was 16600. Then, the ion intensity Y of Li⁺ at the interface between the pressure-sensitive adhesive layer and the transparent resin layer was obtained, Y of Example 1 was 21400. Therefore, Y/X of Example 1 was 1.3.

<Confirmation of Segregation of Additives>

It was confirmed by TOF-SIMS that the additive segregated on the pressure-sensitive adhesive layer side surface in the transparent resin layer. The pressure-sensitive adhesive was peeled from the pressure-sensitive-adhesive-layer-attached polarizing film and the depth profile was observed by TOF-SIMS equipped with a gas cluster ion gun from the surface of the transparent resin layer from which the pressure-sensitive adhesive was peeled off.

<Anchoring Power>

The pressure-sensitive-adhesive-layer-attached polarizing films obtained in Examples and Comparative Examples were cut to a size of 25 mm×150 mm, and the pressure-sensitive adhesive layer surface of this polarizing film and the vapor deposition surface of the vapor deposited film formed by vapor deposition of indium-tin oxide on the surface of a polyethylene terephthalate film having a thickness of 50 μm were bonded in contact with each other. Thereafter, the end portion of the polyethylene terephthalate film was manually peeled off, so that it was confirmed that the pressure-sensitive adhesive layer was adhered to the polyethylene terephthalate film side, and then the stress (N/25 mm) at the time of peeling at a rate of 300 mm/min in the direction of 180° was measured (25° C.) using a tensile tester AG-1 manufactured by Shimadzu Corporation.

It is favorable that the anchoring power is 15 N/25 mm or more, because of no adhesive residue at the time of reworking and no adhesive deficiency upon processing.

<Surface Resistance>

After the separator film was peeled off from the pressure-sensitive-adhesive-layer-attached polarizing film, the surface resistance (Ω/square) of the pressure-sensitive adhesive surface was measured with MCP-HT450 manufactured by Mitsubishi Chemical Analytech Co., Ltd. The surface resistance is preferably 1.0×10¹¹ Ω/square or less.

<Confirmation of Crack: Long Time Test at High Temperature>

A piece with a size of 400 mm wide×708 mm long (400 mm in the absorption axis direction) and a piece with a size of 708 mm long×400 mm wide (708 mm in the absorption axis direction) were cut from each resulting pressure-sensitive-adhesive-layer-attached polarizing film. The cut pieces were bonded in the directions of crossed Nicols to both sides of a non-alkali glass of 402 mm wide×710 mm long×1.3 mm thick to form a sample. The sample was stored in an oven at 35° C. for 250 hours. Subsequently, the sample was taken out and then visually observed for whether cracking occurred in the pressure-sensitive-adhesive-layer-attached polarizing film. This test was performed using 10 pieces for each sample. The number of cracked sample pieces was counted.

<Moist Heat Resistance (Rate of Change in Polarization Degree (Optical Reliability Test))>

A piece with a size of 25 mm×50 mm (50 mm in the absorption axis direction) was cut from each resulting one-side-protected polarizing film. The cut piece (sample) of the one-side-protected polarizing film was stored in a thermo-hygrostat at 85° C. and 85% RH for 150 hours. The polarization degree of the one-side-protected polarizing film sample was measured before and after the storage using an integrating sphere-equipped spectral transmittance meter (DOT-3C manufactured by Murakami Color Research Laboratory Co., Ltd.), and used for the calculation of: rate (%) of change in polarization degree=(1−(the polarization degree after the storage)/(the polarization degree before the storage)).

The polarization degree P is calculated from the formula below using the transmittance (parallel transmittance Tp) of a laminate of the same two polarizing films with their transmission axes parallel to each other and the transmittance (crossed transmittance Tc) of a laminate of the same two polarizing films with their transmission axes orthogonal to each other. Polarization degree P (%)={(Tp−Tc)/(Tp+Tc)}^{1/2}×100

Each transmittance was expressed as the Y value, which was obtained through luminosity correction using the two-degree field (illuminant C) according to JIS Z 8701 when the transmittance for completely polarized light obtained through a Glan-Taylor prism polarizer was normalized to 100%.

TABLE 1

| | | | | | Transparent resin layer (PVA-based resin layer) | | | | | |
|---|---|---|---|---|---|---|---|---|---|---|
| | | | | | | | | | Additive | |
| | One-side protected polarizing film | | | | | PVA-based resin | | | (parts by weight) | |
| | Polarizing | Single-body | Polarization | Boric acid | | Saponification | | | Terminal | Terminal |
| | film | transmittance | degree P | content | | degree | Polymerization | PVA | primary | amino |
| | thickness | T (%) | (%) | (wt %) | Thickness | (%) | degree | modification | alcohol | group |
| Example 1 | 5 μm | 42.8 | 99.99 | 16.40% | 1.0 μm | 99.7 | 2500 | — | 5.0 | — |
| Example 2 | 5 μm | 42.8 | 99.99 | 16.20% | 1.0 μm | 99.7 | 2500 | — | 10.0 | — |
| Example 3 | 5 μm | 42.8 | 99.99 | 15.80% | 1.0 μm | 99.7 | 2500 | — | 3.0 | — |
| Example 4 | 5 μm | 42.8 | 99.99 | 15.80% | 1.0 μm | 99.7 | 2500 | — | 1.0 | — |
| Example 5 | 5 μm | 42.8 | 99.99 | 15.90% | 1.0 μm | 99.7 | 2500 | — | — | 5.0 |
| Example 6 | 5 μm | 42.8 | 99.99 | 16.60% | 1.0 μm | 95.0 | 500 | — | 5.0 | — |
| Example 7 | 5 μm | 42.8 | 99.99 | 16.20% | 3.3 μm | 99.7 | 2500 | — | 5.0 | — |
| Example 8 | 5 μm | 42.8 | 99.99 | 15.90% | 6.0 μm | 99.7 | 2500 | — | 5.0 | — |
| Example 9 | 5 μm | 42.8 | 99.99 | 15.80% | 0.2 μm | 99.7 | 2500 | — | 5.0 | — |
| Example 10 | 5 μm | 42.8 | 99.99 | 15.90% | 1.0 μm | 99.7 | 2500 | — | 0.3 | — |
| Example 11 | 5 μm | 42.8 | 99.99 | 16.10% | 1.0 μm | 99.7 | 2500 | — | 10.0 | — |
| Comparative | 5 μm | 42.8 | 99.99 | 16.20% | 1.0 μm | 99.7 | 2500 | — | — | — |
| Example 1 | | | | | | | | | | |
| Comparative | 5 μm | 42.8 | 99.99 | 16.10% | 1.0 μm | 99.7 | 2500 | — | 5.0 | — |
| Example 2 | | | | | | | | | | |
| Comparative | 5 μm | 42.8 | 99.99 | 15.90% | 1.0 μm | 99.7 | 2500 | — | 5.0 | — |
| Example 3 | | | | | | | | | | |
| Comparative | 5 μm | 42.8 | 99.99 | 15.90% | — | — | — | — | — | — |
| Example 4 | | | | | | | | | | |

| | | | | | | | Evaluation | | | |
|---|---|---|---|---|---|---|---|---|---|---|
| | Pressure-sensitive | | | | | | | | Number of | |
| | adhesive layer | | | Abundance ratio of | | | | | sheets | Optical |
| | Alkali | Acrylic-based | | alkali metal salt (%) | | | | | where | reliability |
| | metal | polymer | | Pressure- | | | | | cracks | (Moisture |
| | salt | Presence or | | sensitive | Interface of | | | Conductivity | occurred in | resistance) |
| | Amount | absence of | Crosslinking | adhesive | transparent | | Anchoring | Surface | crack test | Change in |
| | (parts by | hydroxyl | agent | layer | resin layer | Ratio | power | resistivity | (Number of | polarization |
| | weight) | group | Kind | X | Y | Y/X | (N/25 mm) | (Ω/□) | sheets) | degree |
| Example 1 | 1.00 | Presence | Isocyanate- | 16600 | 21400 | 1.3 | 19.9 | 3.1E+10 | 0 | 0.23% |
| | | | based | | | | | | | |
| Example 2 | 1.00 | Presence | Isocyanate- | 17200 | 18300 | 1.1 | 21.2 | 2.1E+10 | 0 | 0.32% |
| | | | based | | | | | | | |
| Example 3 | 1.00 | Presence | Isocyanate- | 16300 | 24400 | 1.5 | 17.4 | 3.7E+10 | 0 | 0.10% |
| | | | based | | | | | | | |
| Example 4 | 1.00 | Presence | Isocyanate- | 15800 | 33300 | 2.1 | 16.9 | 5.2E+10 | 0 | 0.22% |
| | | | based | | | | | | | |
| Example 5 | 1.00 | Presence | Isocyanate- | 16400 | 21300 | 1.3 | 19.8 | 3.0E+10 | 0 | 0.45% |
| | | | based | | | | | | | |
| Example 6 | 1.00 | Presence | Isocyanate- | 15500 | 39000 | 2.5 | 19.0 | 4.7E+10 | 1 | 1.25% |
| | | | based | | | | | | | |
| Example 7 | 1.00 | Presence | Isocyanate- | 17000 | 16500 | 1.0 | 20.5 | 3.9E+10 | 0 | 3.50% |
| | | | based | | | | | | | |
| Example 8 | 1.00 | Presence | Isocyanate- | 17800 | 8800 | 0.5 | 22.0 | 6.1E+10 | 0 | 10.11% |
| | | | based | | | | | | | |
| Example 9 | 1.00 | Presence | Isocyanate- | 15400 | 42000 | 2.7 | 15.5 | 3.0E+10 | 1 | 0.19% |
| | | | based | | | | | | | |
| Example 10 | 0.25 | Presence | Isocyanate- | 4100 | 6100 | 1.5 | 18.0 | 7.5E+10 | 0 | 0.14% |
| | | | based | | | | | | | |
| Example 11 | 5.00 | Presence | Isocyanate- | 76800 | 215100 | 2.8 | 15.4 | 1.7E+10 | 0 | 0.57% |
| | | | based | | | | | | | |
| Comparative | 1.00 | Presence | Isocyanate- | 13500 | 78600 | 5.8 | 8.4 | 7.4E+10 | 0 | 0.19% |
| Example 1 | | | based | | | | | | | |
| Comparative | 0.05 | Presence | Isocyanate- | 840 | 690 | 0.8 | 20.0 | 2.6E+11 | 0 | 0.22% |
| Example 2 | | | based | | | | | | | |
| Comparative | — | Presence | Isocyanate- | — | — | — | 19.7 | 2.2E+11 | 0 | 0.18% |
| Example 3 | | | based | | | | | | | |
| Comparative | 1.00 | Presence | Isocyanate- | 16700 | 16000 | 1.0 | 19.7 | 2.8E+10 | 10 | 0.20% |
| Example 4 | | | based | | | | | | | |

In Table 1, the alkali metal salt represents lithium bis(trifluoromethanesulfonyl)imide (manufactured by Mitsubishi Materials Electronic Chemicals Co., Ltd.); the terminal primary alcohol represents methylol melamine, Water Sol S-695 (manufactured by DIC Corporation); and the terminal amino group represents hydrazine monohydrate (manufactured by Showa Chemical Industry Co., Ltd.).

### DESCRIPTION OF REFERENCE SIGNS

1 Polarizer

2 Transparent resin layer (mainly composed of polyvinyl alcohol-based resin)

3 Pressure-sensitive adhesive layer

4 Separator

5 Protective film

10 Pressure-sensitive-adhesive-layer-attached polarizing film

11 Pressure-sensitive-adhesive-layer-attached polarizing film

1. A pressure-sensitive-adhesive-layer-attached polarizing film having, in this order, a polarizer containing a polyvinyl alcohol-based resin, a transparent resin layer containing a polyvinyl alcohol-based resin, and a pressure-sensitive adhesive layer, wherein the pressure-sensitive adhesive layer is formed from a pressure-sensitive adhesive composition containing at least 0.1 parts by weight of an alkali metal salt with respect to 100 parts by weight of a base polymer, and satisfying the general expression (Y/X)≦3, where X is the abundance ratio of the alkali metal salt in a center part in the thickness direction of the pressure-sensitive adhesive layer, and Y is the abundance ratio of the alkali metal salt in the interface between the pressure-sensitive adhesive layer and the transparent resin layer.

2. The pressure-sensitive-adhesive-layer-attached polarizing film according to claim 1, wherein the transparent resin layer is formed from a polyvinyl alcohol-based resin composition containing 0.2 to 20 parts by weight of an additive having a functional group capable of reacting with the functional group of the pressure-sensitive adhesive composition with respect to 100 parts by weight of the polyvinyl alcohol-based resin.

3. The pressure-sensitive-adhesive-layer-attached polarizing film according to claim 2, wherein the additive segregates on the surface of the pressure-sensitive adhesive layer side of the transparent resin layer.

4. The pressure-sensitive-adhesive-layer-attached polarizing film according to claim 2, wherein the additive has at least one primary alcohol at the molecular terminal.

5. The pressure-sensitive-adhesive-layer-attached polarizing film according to claim 2, wherein the additive has a primary or secondary amino group in the molecule.

6. The pressure-sensitive-adhesive-layer-attached polarizing film according to claim 1, wherein the polyvinyl alcohol-based resin contained in the transparent resin layer has a saponification degree of 96 mol % or more and an average polymerization degree of 2000 or more.

7. The pressure-sensitive-adhesive-layer-attached polarizing film according to claim 1, wherein the transparent resin layer has a thickness of 0.2 μm or more and 6 μm or less.

8. The pressure-sensitive-adhesive-layer-attached polarizing film according to claim 1, wherein the pressure-sensitive adhesive composition contains a (meth)acrylic-based polymer as the base polymer and further contains a crosslinking agent.

9. The pressure-sensitive-adhesive-layer-attached polarizing film according to claim 8, wherein the (meth)acrylic-based polymer includes a hydroxyl group-containing monomer as a monomer unit.

10. The pressure-sensitive-adhesive-layer-attached polarizing film according to claim 8, wherein the crosslinking agent includes an isocyanate-based compound.

11. The pressure-sensitive-adhesive-layer-attached polarizing film according to claim 1, wherein the alkali metal salt includes a lithium salt.

12. The pressure-sensitive-adhesive-layer-attached polarizing film according to claim 1, wherein the polarizer has a thickness of 15 μm or less.

13. The pressure-sensitive-adhesive-layer-attached polarizing film according to claim 1, wherein the polarizer contains boric acid in an amount of 20% by weight or less with respect to the total amount of the polarizer.

14. The pressure-sensitive-adhesive-layer-attached polarizing film according to claim 1, wherein the polarizer is configured in such a manner that the optical characteristics represented by the single-body transmittance T and the polarization degree P satisfy the condition of the following expression; P>−(10^{0.929T-42.4}−1)×100 (where T<42.3) or P≧99.9 (where T≧42.3).

15. The pressure-sensitive-adhesive-layer-attached polarizing film according to claim 1, wherein a protective film is provided on the side opposite to the side where the transparent resin layer of the polarizer is provided.

16. The pressure-sensitive-adhesive-layer-attached polarizing film according to claim 1, wherein a separator is laminated on the pressure-sensitive adhesive layer.

17. The pressure-sensitive-adhesive-layer-attached polarizing film according to claim 16, which is in the form of a roll.

18. A method for producing the pressure-sensitive-adhesive-layer-attached polarizing film according to claim 1, comprising;
a step of coating a polyvinyl alcohol-based resin-containing polyvinyl alcohol-based resin composition on a polarizer containing a polyvinyl alcohol-based resin and then drying to form a transparent resin layer, and
a step of forming a pressure-sensitive adhesive layer on the transparent resin layer from a pressure-sensitive adhesive composition containing at least 0.1 parts by weight of an alkali metal salt with respect to 100 parts by weight of a base polymer.

19. An image display device having the pressure-sensitive-adhesive-layer-attached polarizing film according to claim 1.

20. A method for continuously producing an image display device, the method comprising the steps of:
unwinding the pressure-sensitive-adhesive-layer-attached polarizing film from the roll of the pressure-sensitive-adhesive-layer-attached polarizing film according to claim 16;
feeding the pressure-sensitive-adhesive-layer-attached polarizing film with the separator; and
continuously bonding the pressure-sensitive-adhesive-layer-attached polarizing film to a surface of an image display panel with the pressure-sensitive adhesive layer interposed therebetween.
